(19) United States
(12) Patent Application Publication
(10) Pub. No.: US 2022/0061344 A1
(43) Pub. Date: Mar. 3, 2022

(54) VEGETABLE CONSERVATION PROCESS

(71) Applicant: Augusto Cesar Fernandini Frias, Lima (PE)

(72) Inventor: Augusto Cesar Fernandini Frias, Lima (PE)

(21) Appl. No.: 17/197,187

(22) Filed: Mar. 10, 2021

(30) Foreign Application Priority Data
Sep. 2, 2020 (PE) 1345-2020/DIN

(51) Int. Cl. A23B 7/10; A23L 5/10

(52) U.S. Cl. CPC A23B 7/10; A23L 5/19

(57) ABSTRACT

The present invention refers to a process for the conservation of vegetables which comprises the steps of selecting a vegetable, performing a first immersion of the vegetable in a first solution which is an antioxidant solution comprising citric acid and ascorbic acid, performing a second immersion in a second solution which is an antioxidant solution comprising citric acid, ascorbic acid and sodium chloride, cook in a third solution comprising citric acid, ascorbic acid and sodium chloride, hydrocooling the vegetable with the third solution, perform a third immersion in a fourth solution which is an edible coating solution, bag the vegetable, and perform a seal with active or passive modified atmosphere or a vacuum seal.

### FIELD OF INVENTION

The present invention is in the technical field of vegetable conservation.

### STATE OF THE ART

There are various processes and compositions in the state of the art that are aimed to increase the shelf life of vegetables. These methods are directed to avoid the environment effects on the vegetable, decrease the action of the corresponding enzymes or micro-organisms by using physical or chemical processes, such as polymeric coverings or the action of antioxidants.

Patent document US2019281845, describes bioactive edible films based on chitosan or a mixture of quinoa and protein-chitosan; leaves that contain nanoparticles of chitosan-tripolyphosphate-thymol; production method; bio-packaging comprising the same; and its use in fresh fruit with a low pH.

Patent document CN109953113 belongs to the post-harvest technology in the fruit and vegetable field, specifically describes a kind of edible corn starch film non-stick agent and its method of preparation, application and method of fruit and vegetable preservation. The edible corn starch film non-stick agent of the invention includes the following raw material components: beta-cyclodextrin, hydroxypropyl-β-cyclodextrin, bletilla striata polyoses glue, hydroxyethyl cellulose, nano silica, ginkgo biloba extract, plantaginis seed extract, coconut peel extract, cinnamon essential oil, litsea cubeba oil and Chinese squalene essential oil. The anti-scaling agent not only can effectively carry out fresh maintenance, but it is also safe and non-toxic, edible and has some efficacy for the health care of fruits and vegetables.

Patent document CN109385098 describes the method of preparing edible plastic wrapping of fruits and vegetables, and specifically includes soybean grinding, enzymatic hydrolysis, centrifugation, dried bean residues and crushing, high-pressure homogeneous cellulase hydrolysis, precipitated centrifugation, ultrasonic mixing, coating drying and other stages.

Patent document CN108967529 adds in potato starch solution: carrageenan thickener, glycerol thickener, fruit enamel, chitosan agent, sodium benzoate sodium benzoate preservative and distilled water, which are evenly and continuously mixed, heating for 20 minutes. Finally, it is cooled to room temperature and a clear liquid emulsion of fresh maintenance film coating is made.

Patent document CN107980897 includes the following components percentage: pure water between 83.0%-91.0%, glycerin between 2.0%-6.0%, eucalyptus oil 2.0%, converted starch between 1.0%-3.0%, glyceryl monostearate between 1.0%-3.0%, sucrose fatty ester 1.0%-3.0%, calcium chloride 0.4%-1.0%, arabic gum 0.2%-0.8%.

Patent document CN107903641 uses celery-soluble extraction dietary fiber with sodium chloride solution, dissolved in Japanese plum resin, to increase the human body digestion to the preservative film, and is utilized as an acidity regulator by using sodium citrate, thus maintaining the acid-base value of the film.

Patent document CN107446361 describes an edible thin layer that maintains freshness, made from raw material with the following parts by weight: between 20-24 parts of Pericarpium Zanthoxyli extract, between 8-10 parts of pea starch, 68 parts of peanut powder, 46 parts of agar, between 10-14 parts of gelatin, 48 parts of caryophyllus oil, between 4-10 parts of catechin, 48 parts of casein, 46 parts of weeping forsythia powder capsule, 48 parts o range peel powder, 48 parts chitosan, 4 -10 parts ascorbic acid and 4-12 parts sodium alginate.

Patent document CN107087678 describes a method of preparing the edible film for vegetable maintenance, which includes the following steps: Step 1: Prepare an edible solution for the maintenance film, take polysaccharides and add water to dissolve them, put it in a hot water bath between 70° C.-90° C., and wait until completely dissolves, then add the emulsifier and plasticizer, cool to 60° C., add the proteins, agitate for 1 to 3 hours in water bath conditions, add between 2% to 10% calcium chloride and cool to room temperature for 40 minutes. The edible fresh maintenance film solution is obtained in approximately 40 minutes. Step 2: Soak the fresh vegetables in the fresh film solution, remove it and quickly air dry, or uniformly spray the fresh film liquid onto the surface of the fresh vegetables. The maintenance edible film is mainly made of polysaccharides and proteins. The fresh preservation film prepared is edible, has good barrier properties against moisture and gases, is transparent and bright, and significantly improves the shelf life.

Patent document CN107603238 describes a liquid edible fruit maintenance film, a fresh maintenance product and a method for its preparation and application, which are characterized by being composed of the following raw materials in parts by weight: 20 parts of aloe gel, 20 to 40 parts of solution between 2% and 4% fish scale jelly, 4 parts of vegetable essential oil and 3 parts plasticizer. The preparation method includes the preparation of aloe gel; the preparation of the fish scale jelly solution; the preparation of the fresh maintenance fluid. The advantage of the invention are its mechanical properties, UV blocking properties and good bacteriostatic properties, especially suitable for fruits that are susceptible to mold infection.

Patent document MX2015014317 describes an edible bilayer coating based on a formulated plant mucilage (as aniconic polymer) and a chitosan formulation (as cationic polymer) to extend the Sell by Date of cut fruits. The use of this edible coating confers advantages on the fresh cut product, such as: reduction in weight loss and firmness, delay in changes in the total content of soluble solids and decreased degradation of vitamin C, as well as protection against development of altering microorganisms (aerobic mesophiles, fungi, yeasts and psychrotrophs) and maintenance of the sensory quality (color, smell, taste, texture, decay rate and global acceptance), prolonging the Sell by Date of the natural product by up to 18 days.

Patent document MX2015014327 provides an edible bilayer coating based on a chitosan formulation (as cationic polymer) and a pullulan formulation (as a neutral polymer), to extend the Sell by Date of cut fruits. The use of the bi-layered edible coatings based on the aforementioned polymers decreases the weight loss and firmness of the fruit, helps to delay changes in the total content of soluble solids and functions as a protection barrier against the development of altering microorganisms, thus maintaining the sensory quality of the product, and prolonging the Sell by Date for up to 18 days.

Patent document CN105211276 refers to a type of edible non-stick coating agent for freshly cut fruit and its method of preparation and application. This non-stick agent comprises pullulan polysaccharide, anthocyanidin, antioxidant, emulsifying agent, calcium chloride, calcium nanocarbonate, and various ingredients such as stearate. The pullulan polysaccharide is the colorless and odorless polymeric substance, which has edibility and biodegradability, with a good film formation, with a good gas barrier property and water prevention capacity, which is extremely suitable for the fresh maintenance of the food coating film such as a fruit.

Patent document RO130655 consists of a gluten-based edible wheat coating from an aqueous solution containing gluten 9.0 g, 95% 32.5 ml ethanol, glycerol 1.8 g, NH₄OH 6N ˜8.4 ml (up to pH=10), lemon essential oil 1 g and distilled water up to 100 ml. The lemon essential oil was obtained by distillation with water and steam from the lemon peel, dried over anhydrous sodium sulfate and filtration. The film forming solution is obtained by dissolving glycerol and gluten in ethanol. The mixture is homogenized with a magnetic stirrer, distilled water and NH₄OH 6N are gradually added, to adjust the pH to 10, a condition necessary for protein dispersion.

Patent document CN103719267 describes a method of preparing a new edible fruit and vegetable maintenance agent coated with an edible film. The preparation method includes the following steps: weighing between 10 and 18 parts of pectin, between 8 to 15 parts of glucose, between 3 and 8 parts of tea polyphenol, between 5 and 15 parts of chitosan carboxymethyl, between 3 to 8 parts of Vc-sodium, between 0.5 to 2 parts natamycin, between 3 to 8 parts citric acid and between 10 to 20 parts ethyl alcohol according to the formula. The components are then dissolved in a corresponding amount of water at between 30° C. and 50° C., to prepare the edible fruit coated with film and plant maintenance agent.

Patent document CN103583676 describes a method for preparing an edible preservative film solution with the following steps: Step 1: add water to dissolve the polysaccharide, and perform a water “Maria” bath at between 70° C. and 90° C., until the polysaccharide is completely gelatinized; Step 2: add an emulsifying agent and a plasticizing agent; Step 3: after cooling the mixture to 60° C., add the protein; Step 4: stir the mixture for 1 to 3 hours under the water “Maria” bath condition; Step 5: add calcium chloride; and Step 6: cool the mixture to room temperature, then obtain the preservative film solution and, soak the fresh fruit in the preservative film solution, remove and quickly air dry, or spray the preservative film solution on the skin of the fresh fruit, and form the preservative film after a quick air drying.

Patent document CN101006775 consists of a plastic composed of zein, mannose fatty acid ester, hexaphosphoric acid inositol, aminoacetic acid, tween-80 and water, and is prepared as follows: take zeine as a basic material, mix zein with mannose fatty acid ester according to the proportion ingredient to emulsify and dissolve the zein, adding hexaphosphoric acid inositol, aminoacetic acid, tween-80 and water according to the proportion of the ingredient, heating the mixture, stirring evenly and removing the foams that are generated during the stirring process to obtain the final product.

Patent document CN1466883 consists of an edible plant preservative of a two-component coating, preservative component B and component A. Component A comprises: a polysaccharide in an amount of 1% to 10% by weight, a preservative in a percentage by weight of 0.01% to 1%, a surfactant in a percentage by weight of 0.1% to 2%, an antioxidant in a percentage by weight of 0.01% to 1%, water in a percentage by weight of 86% to 98%. Component B comprises: a water-blocking agent in a percentage by weight of 1% to 20%, the surfactant at a percentage by weight of 0.1% to 5%, and a solvent in a percentage by weight of 75% to 98.9%.

Patent document MX2014013526 proposes the formulation of edible biodegradable coatings as a new natural storage alternative that makes it possible to extend the Sell by Date of fruits and vegetables. The development of a polymethacrylate-based coating is considered, which is a highly resistant and biodegradable polymer used for the prolonged release of active ingredients to which Thymus vulgaris (thyme) essential oil nanoparticles are incorporated, which is a low-cost product, is a powerful antioxidant and natural antimicrobial that significantly improves the quality and Sell by Date of treated fruits and vegetables by staying intact on the coating for a longer time and being released in a prolonged way.

Patent document MX2014013173 proposes the formulation of edible organic and biodegradable coatings as a new natural storage alternative that makes it possible to extend the Sell by Date of fruits and vegetables. The development of a chitosan-based coating is considered which is a highly resistant and biodegradable polymer with a wide antimicrobial spectrum, used for the prolonged release of active ingredients; to which nanocapsules of essential oil of Lippia berlandieri (oregano) are incorporated, which is a product endemic in Mexico and with a low cost in the country. It is a powerful antioxidant and natural antimicrobial that significantly improves the quality and Sell by Date of treated fruits and vegetables by staying intact in to coating for a longer time and being released in a prolonged manner. The development of this project contributes not only to the generation of biotechnological and novel products that can address the problems of the agri-food area, but also to the development of rural communities that promote the sale of oregano.

Patent document WO2004032654 comprises a dry fruit provided and at least one coating layer based on an edible compound, the latter being selected from hydroxypropyl methylcellulose, hydroxypropyl cellulose, methylcellulose, carboxymethylcellulose, ethyl methyl cellulose, arabic gum, maltodextrin, a lipid or a combination of various lipids, and their mixtures. The edible coating acts as a protection that extends the shelf life of the dried fruit and potentially serves as a support for additives that modify the original characteristics of the dried fruit.

The process a process like that of our present invention has not been revealed in the state of the art.

### BRIEF DESCRIPTION OF THE INVENTION

The present invention refers to a process for vegetable conservation. The process comprises the following steps:
a. select a vegetable,
b. carry out a first immersion of the vegetable in a first solution which is an antioxidant solution,
c. carry out a second immersion into a second solution which is an antioxidant solution,
d. cook in a third solution,
e. hydrocool the vegetable with the third solution,
f. carry out a third immersion into a fourth solution that is an edible coating solution,
g. bag the vegetable, and
h. seal the bag.

In a preferred embodiment, the process for vegetable conservation comprises the following steps:
a. select a vegetable,
b. wash, disinfect and peel the vegetable,
c. carry out a first immersion in a first solution comprising citric acid and ascorbic acid for at least 5 minutes,
d. carry out a second immersion in a second solution comprising citric acid, ascorbic acid and sodium chloride for at least 5 minutes,
e. cook in a third solution comprising citric acid, ascorbic acid and sodium chloride at temperature of at least 80° C. for a time of between 4 to 20 minutes,
f. hydrocool in the third solution until the vegetable temperature is less than 6° C.,
g. carry out a third immersion in a fourth edible coating solution comprising a combination of ascorbic acid and calcium, chitosan, or a mixture thereof, for about 8 to 12 minutes where the temperature of the solution is less than 6° C.,
h. drain the surplus solution,
i. bag and with an active modified atmosphere, passive or vacuum sealing.

Preferably, the conservation process for the artichokes (Cynara scolymus) comprises the following steps:
a. select an artichoke in good condition,
b. wash the artichoke with a detergent for vegetables,
c. disinfect with peracetic acid with a concentration of approximately 100 ppm,
d. remove the artichoke leaves,
e. carry out a first immersion in a first antioxidant solution comprising citric acid at a concentration of approximately 0.5 to 1.5% and ascorbic acid at a concentration of approximately 0.1 to 1%, relative to the total weight of the solution,
f. form the artichoke bottom,
g. perform a second immersion of the artichoke bottom in a second antioxidant solution comprising citric acid at a concentration of approximately 0.1 to 1%, ascorbic acid at a concentration of approximately 0.1 to 0.5% and sodium chloride at a concentration of approximately 0.5 to 1%, relative to the total weight of the solution,
h. cook the artichoke bottom in a third solution comprising citric acid at a concentration of approximately 0.1 to 0.5%, ascorbic acid at a concentration of approximately 0.05 to 0.15% and sodium chloride at a concentration of approximately 0.1 to 0.5%, relative to the total weight of the solution, where cooking is done at a temperature of approximately 85 to 105° C. for a time of between 4 to 20 minutes,
i. hydrocool the artichoke bottom in the third solution until the temperature of the artichoke bottom is approximately less than 10° C.,
j. carry out a third immersion of the artichoke bottom into a fourth edible coating solution comprising, a combination of ascorbic acid and calcium, at a concentration of approximately 10 to 16% where the ascorbate ions and calcium ions are at a ratio of 1.5:1 to 3:1, chitosan at a concentration of approximately 0.1 to 1%, relative to the total weight of the solution, or a mixture of both; for a time of at least 8 minutes, where the temperature of the fourth solution is less than 6° C.,
k. drain the surplus solution while maintaining a bottom temperature to approximately between 5 to 20° C.,
l. pack in a bag and seal the artichoke bottom with an active modified atmosphere, with an injection of a mixture of gases at a concentration of between 50 to 70% consisting of 2 to 6% of O₂, 8 to 12% CO₂, and 82 to 90% of N₂,
m. store and transport the artichoke bottom at a temperature below 5° C.

### BRIEF DESCRIPTION OF THE FIGURES

FIG. 1. Ranking analysis results of the visual appearance on bag of example 1.

FIG. 2. Shelf life results of 5^{th} Range artichoke bottoms of example 1.

FIG. 3. Color evaluation results of the of artichoke bottoms in 5^{th} Range of example 1.

FIG. 4. Taste assessment results of the of artichoke bottoms in 5^{th} Range of example 1.

FIG. 5. Texture evaluation results of the artichoke bottoms in 5^{th} Range of example 1.

FIG. 6. Odor assessment results of the artichoke bottoms in 5^{th} Range of example 1.

FIG. 7. Ranking analysis results of the visual appearance on bag of example 2.

FIG. 8. Shelf-life results of the 5^{th} Range artichoke bottoms of example 2.

FIG. 9. Color evaluation results of the 5^{th} Range artichoke bottoms of example 2.

FIG. 10. Taste assessment results of the 5^{th} Range artichoke bottoms of example 2.

FIG. 11. Texture assessment results of the 5^{th} Range artichoke bottoms of example 2.

FIG. 12. Odor assessment results of the 5^{th} Range artichoke bottoms of example 2.

FIG. 13. Ranking analysis results of the visual appearance on bag of example 3.

FIG. 14. Shelf-life results of the 5^{th} Range artichoke bottoms of example 3.

FIG. 15. Color evaluation results of the 5^{th} Range artichoke bottoms of example 3.

FIG. 16. Taste assessment results of the 5^{th} Range artichoke bottoms of example 3.

FIG. 17. Texture assessment results of the 5^{th} Range artichoke bottoms of example 3.

FIG. 18. Odor assessment results of the 5^{th} Range artichoke bottoms of example 3.

FIG. 19. Ranking analysis results of the visual appearance on bag of example 4.

FIG. 20. Shelf life results of the 5^{th} Range artichoke bottoms of example 4.

FIG. 21. Color evaluation results of the 5^{th} Range artichoke bottoms of example 4.

FIG. 22. Taste assessment results of the 5^{th} Range artichoke bottoms of example 4.

FIG. 23. Texture assessment results of the 5^{th} Range artichoke bottoms of example 4.

FIG. 24. Odor assessment results of the 5^{th} Range artichoke bottoms of example 4.

### DETAILED DESCRIPTION OF THE INVENTION:

5^{th} Range products are those foods that can be made up of several raw or pre-cooked ingredients, mostly vacuum-packed, that have received a pasteurization or other low-intensity thermal treatment, whose sensory and nutritional quality is similar to that of the freshly made product, and can be consumed quickly without the application of a prolonged preparation processes. The Shelf life of these products can vary between 2 and 6 months (in refrigeration), and up to 12 months depending on the intensity of the heat treatment applied.

Ready to Eat foods are an innovative proposal from the food industry, based on the new consumer trends in the most demanding markets, such as Europe, North America and Japan, and which is committed to a new way of offering the product. These ready to eat products only need a few minutes in an oven or microwave to be consumed.

Ready-to-use foods are foods, such as vegetables, that are easy to eat and do not require an additional procedure to incorporate them into the preparation of meals.

The present invention refers to a process for the conservation of vegetables, the process comprises the following steps:
a. select a vegetable,
b. carry out a first immersion of the vegetable in a first solution which is an antioxidant solution,
c. carry out a second immersion into a second solution which is an antioxidant solution,
d. cook in a third solution,
e. hydrocool the vegetable with the third solution,
f. carry out a third immersion into a fourth solution that is an edible coating solution,
g. bag the vegetable, and
h. seal the bag.

In an embodiment, the vegetable, or raw material, has to be fresh, clean and free of defects, that is, free of necrosis and in a suggested size of about 5 to 15 cm, where bigger or smaller sizes can be used. In a more preferred embodiment, the vegetable is selected from the following group, but not limited to: varieties of Cynara scolymus “artichoke”; species and varieties of the Capsicum genus; varieties of Pisum sativum such as green peas, pea, sweet pea or snow pea; varieties of Asparagus officinalis “asparagus”; varieties of Phaseolus Vulgaris such as fine and extra fine pods; the raw material can also refer to fruits.

In an embodiment, the vegetable is stored, washed, and disinfected, where the storage of raw material is done at a temperature of approximately 15 to 25° C., where other vegetables are stored at temperatures below 5° C., as appropriate. Washing is done with a detergent, preferably detercan® at a concentration of at least 0.25% for at least 8 minutes. Disinfection is performed with disinfectants suitable for vegetables, preferably with peracetic acid at a concentration of 100 ppm for at least 5 minutes. In some embodiments a peeling is performed, such as a cut or removal of the leaves or the skin of the raw material.

In an embodiment, the first immersion of the raw material is carried out in a first antioxidant solution comprising citric acid and ascorbic acid, preferably, the citric acid is present in a concentration of at least 0.5% up to 1.5% in relation to the total weight of the first solution, and the ascorbic acid is present in a concentration of at least 0.1% to 1% in relation to the total weight of the first solution; even more preferably, citric acid and ascorbic acid are present in a concentration of approximately 0.8 to 1.2% for citric acid and 0.4 to 0.6% for ascorbic acid, both in relation to the total weight of the first solution. The first immersion is carried out for at least 3 minutes, preferably for at least 5 minutes.

In another embodiment, the bottoms are formed after the first immersion, where the preferred size of the bottoms is around 5 to 10 cm.

In one embodiment, the second immersion of the raw material is carried out in a second antioxidant solution comprising citric acid, ascorbic acid and sodium chloride, preferably, the citric acid is present in a concentration of at least 0.1% up to 1% in relation to the total weight of the second solution, the ascorbic acid is present in a concentration of at least 0.1% up to 0.5% in relation to the total weight of the second solution, and sodium chloride is present in a concentration of at least 0.5% up to 1% in relation to the total weight of the second solution; even more preferably, citric acid, ascorbic acid and sodium chloride are present in a concentration of approximately 0.4 to 0.6%, 0.2 to 0.3%, and 0.65 to 0.85%, respectively, in relation to the total weight of the second solution. The second immersion is carried out for at least 5 minutes, preferably for at least 8 minutes.

In one embodiment, cooking is carried out in a third solution comprising citric acid, ascorbic acid and sodium chloride, preferably cooking is carried out at a temperature of at least 85° C. to 105° C., for a time of 4 to 20 minutes; in a preferred embodiment, citric acid is present in a concentration of 0.1% to 0.5% in relation to the total weight of the third solution, ascorbic acid is present in a concentration of 0.05% to 0.15% in relation to the total weight of the third solution, and sodium chloride is present in a concentration of 0.1% to 0.5% in relation to the total weight of the third solution; even more preferably, citric acid, ascorbic acid and sodium chloride are present in a concentration of approximately 0.1 to 0.3, 0.08 to 0.12, and 0.2 to 0.4%, respectively, in relation to the total weight of the third solution.

In one embodiment, hydrocooling is carried out in the third solution comprising citric acid, ascorbic acid and sodium chloride, where the temperature of the vegetable or the bottoms is sought to reach a temperature of between 2 and 10° C.

In one embodiment, a third immersion is carried out in a fourth solution which is an edible coating solution comprising a combination of ascorbic acid and calcium at a concentration of 10 to 16% in relation to the total weight of the fourth solution, where the ascorbate ions and the calcium ions are in a ratio of 1.5:1 to 3:1, respectively, preferably at a ratio of 2:1 to 2.5:1, respectively.

The ascorbic acid and calcium in the fourth solution also refer to ions of the same, to isomers of ascorbic acid such as erythorbic acid and their respective salts. The combination of ascorbic acid and calcium of the fourth solution also refers to a salt of both such as calcium ascorbate.

In another embodiment, the third immersion is carried out in a fourth solution which is an edible coating solution comprising chitosan at a concentration of between 0.1 to 1% in relation to the total weight of the fourth solution, preferably at a concentration of between 0.4 to 0.6%.

In another embodiment, a third immersion is carried out in a fourth solution which is an edible coating solution comprising a combination of ascorbic acid and calcium, and chitosan, where the combination of ascorbic acid and calcium is at a concentration of 10 to 16% in relation to the total weight of the fourth solution, where the ascorbate ions and the calcium ions are in a ratio of 1.5:1 to 3:1, respectively, preferably at a ratio of 2:1 to 2.5:1, respectively; and chitosan is at a concentration of 0.1 to 1% in relation to the total weight of the fourth solution, preferably at a concentration of 0.4 to 0.6%.

The third immersion is carried out in the fourth solution at a temperature below 6° C., for a time of at least 8 minutes.

In another embodiment, the coating solution is drained, at a temperature of at least approximately 5 to 20° C., for at least 5 minutes, with about 1 minute on each side.

In one embodiment, bagging is done preferably in bags suitable for the bagging of fresh vegetables, such as but not limited to flexible bags of 70 microns.

In an embodiment, the bags are sealed preferably with an active modified atmosphere, which includes an injection of a gas mixture into the bag, at a concentration of between 50 to 70% consisting of 2 to 6% O₂, 8 to 12% CO₂, and 82 to 90% N₂. At the end of this step, the finished product is obtained.

In another embodiment, the finished product is stored, preferably at a temperature below 5° C., and even more preferably between 1 and 3° C.

In another embodiment, the finished product is transported at a temperature below 5° C., preferably between 1 and 3° C.

The process of the present invention allows a shelf life duration of the 5^{th} Range vegetables, when there are 0, 1, 2 or more interruptions in the cooling chain, preferably up to 2 interruptions, of at least 5 days, preferably at least 20 days, and even more preferably for at least 30 days. In some embodiments, at least 45 days of useful shelf life is achieved.

### EXAMPLES OF EMBODIMENTS

### Physicochemical Criteria

Raw material: pH, % Salt, % Acidity, and ° Brix.

Process: bottom thickness, pH, % salt, titratable acidity, and ° brix.

Finished product: gross weight, net weight, pH, % salt, and ° brix.

### Sensory Criteria of the Finished Product

Texture, flavor, color, smell, and appearance.

### Microbiological Criteria for Raw Material and Finished Product

TABLE 1
Microbiological criteria

| Microbiological criteria | U.S. | EU | Peru |
|---|---|---|---|
| Mesophilic aerobes (Cfu /g) | <10,000 | — | <10,000 |
| Escherichia coli (Cfu /g) | <100 | <10 | <10 |
| Coliforms (Cfu /g) | <100 | <100 | <100 |
| Staphylococcus aureus | Absence | Absence | <10 |
| (Cfu /g) | | | |
| Molds (Cfu /g) | <10,000 | <1000 | — |
| Yeasts (Cfu /g) | <10,000 | <1000 | — |
| Salmonella sp. | Absence | Absence | Absence |

### Example 1. 5^{th} Range Artichoke Test, No Cold Chain Interruption (October 2019)

The shelf life assessment test was performed for 30 days, at a storage temperature of between 1 to 3° C. without cold chain interruption.

Design: Table 2 shows the treatments design for testing without cold chain interruption. Treatments M1 to M4 correspond to ready to eat artichoke, while the M5 treatment corresponds to ready to use artichoke.

TABLE 2
Uninterrupted cold chain test.

| | | | | First | Second | | | Edible | |
|---|---|---|---|---|---|---|---|---|---|
| | | | | Immersion | Immersion | Cooking | | Coating | |
| | No | Bag | | (T = ~20° C., | (T = ~20° C., | (T = | Hydrocooling | (T = ~2-3° C., | |
| Sample | bottoms | number | Field | tmin = ~5′) | tmin = ~5′) | ~100° C.) | (T = ~3-5° C.) | t = ~3′) | Packaging |
| M1 | 90 | 30 | A | Citric Acid | Citric acid | t = 12′ | Citric acid | Sol. 13-15% | Active |
| | | | | 0.8-1.2% | 0.4-0.6%, | | 0.1-0.3%, | of Ascorbic | modified |
| | | | | and | Ascorbic | | Ascorbic Acid | Acid and | atmospheres |
| | | | | Ascorbic | Acid 0.2- | | 0.08-0.12% | calcium, | |
| | | | | Acid 0.4- | 0.3% and | | and sodium | Ascorb ion | |
| | | | | 0.6% | sodium | | chloride 0.2- | ratio from | |
| | | | | | chloride | | 0.4% | 2:1 to 2:5. | |
| M2 | 90 | 30 | A | | 0.65-0.85% | | | Sol. mixture | |
| | | | | | | | | 13-15% | |
| | | | | | | | | Ascorbic Ac. | |
| | | | | | | | | and calcium, | |
| | | | | | | | | Ascorb:Ca | |
| | | | | | | | | ion ratio | |
| | | | | | | | | from 2:1 to | |
| | | | | | | | | 2:5 + | |
| | | | | | | | | chitosan 0.4 | |
| | | | | | | | | to 0.6% | |
| M3 | 90 | 30 | B | | | | | Sol. 13-15% | |
| | | | | | | | | Ascorbic Ac. | |
| | | | | | | | | and calcium, | |
| | | | | | | | | Ascorb:Ca | |
| | | | | | | | | ion ratio | |
| | | | | | | | | from 2:1 to | |
| | | | | | | | | 2:5. | |
| M4 | 90 | 30 | B | | | | | Sol. mixture | |
| | | | | | | | | 13-15% | |
| | | | | | | | | Ascorbic Ac. | |
| | | | | | | | | and calcium, | |
| | | | | | | | | Ascorb:Ca | |
| | | | | | | | | ion ratio | |
| | | | | | | | | from 2:1 to | |
| | | | | | | | | 2:5. + | |
| | | | | | | | | chitosan 0.4 | |
| | | | | | | | | to 0.6% | |
| M5 | 36 | 12 | B | | | t = 5′ | | Sol. 13-15% | |
| | | | | | | | | Ascorbic Ac. | |
| | | | | | | | | and calcium, | |
| | | | | | | | | Ascorb:Ca | |
| | | | | | | | | ion ratio | |
| | | | | | | | | from 2:1 to | |
| | | | | | | | | 2:5. | |

T: temperature, t = time, Ascorb:Ca = ratio of ascorbate and calcium ions

### Results

### Raw Material

Raw material (artichoke) Field A: Artichokes from Field A have on average, an equatorial diameter of about 9.28 cm; pH 6.16; 0.47% sodium chloride; 0.20% titratable acidity and 12.50° Brix. Regarding the microbiological analysis, they have an average of 88×10⁴ Cfu/g of mesophilic aerobes, 12×10⁴ Cfu/g of Coliforms, 12×10³ Cfu/g of Molds and 17×10³ Cfu/g of Yeasts.
Raw material (artichoke) Field B: Artichokes from Field B have on average, an equatorial diameter of about 9.84 cm, pH 6.25, 0.40% sodium chloride, 0.16% titratable acidity and 14.50° Brix. Regarding the microbiological analysis, they have an average of 12×10⁵ Cfu/g of mesophilic aerobes, 16×10⁴ Cfu/g of Coliforms, 18×10³ Cfu/g of Molds and 32×10⁴ Cfu/g of Yeasts.

### Visual Appearance of Bags

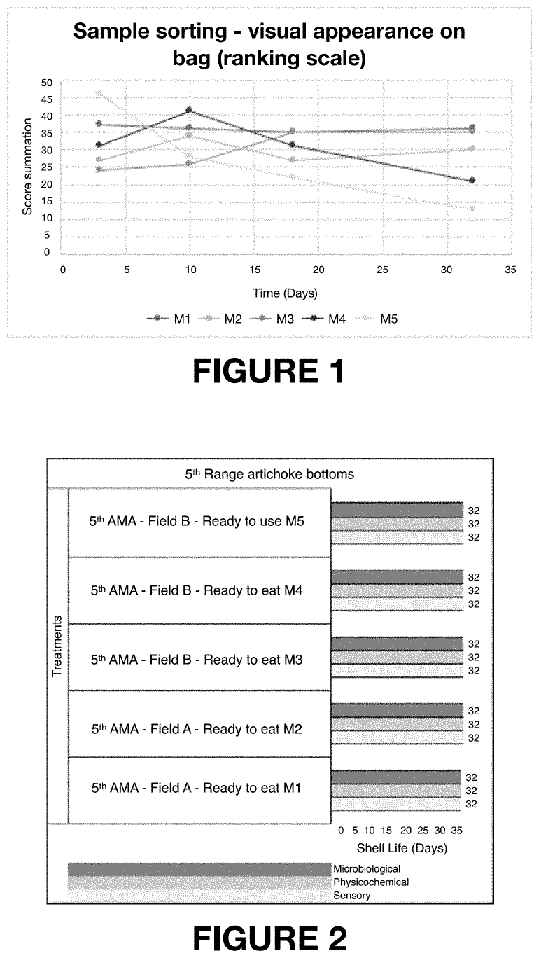

FIG. 1 shows the results obtained from the evaluation of the visual appearance of a bag of 5^{th} Range artichoke bottoms by means of a ranking order. On day 30, treatments M1 and M3 showed better visual appearance followed by treatment M2 and M4. While the M5 treatment showed better visual appearance on day 1, however, it lost visual quality over time.

### Shelf Life of 5^{th} Range Artichoke Bottoms

FIG. 2 shows the results obtained from the sensory evaluation of 5^{th} Range artichoke bottoms by means of a hedonic scale. All the ready-to-eat treatments (M1, M2, M3 and M4) and ready-to-use M5 reached 32 days of shelf life in all the parameters evaluated: physical-chemical, microbiological and sensory.

### Color Assessment of the 5^{th} Range Artichoke Bottoms

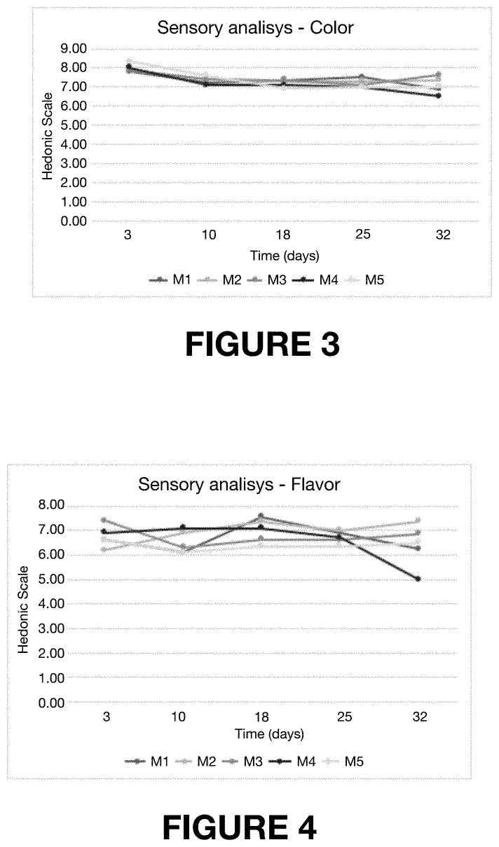

FIG. 3 shows the results obtained from the sensory—color evaluation of the 5^{th} Range artichoke bottoms by means of a hedonic scale, all the ready to eat treatments M1, M2, M3 and M4 and ready to use M5 did not show significant differences between treatments during the 32 days of sensory evaluation.

### Taste Assessment of 5^{th} Range Artichoke Bottoms

FIG. 4 shows the results obtained from the sensory—flavor evaluation of the 5^{th} Range artichoke bottoms by means of a hedonic scale, the ready to eat treatments M1, M2, M3 and ready to use M5 did not present significant differences between treatments during the 32 days of sensory evaluation. While the ready-to-eat M4 treatment with edible coating: mixture of a solution of 13-15% of ascorbic acid and calcium with ionic ratio ascorbate:calcium from 2:1 to 2:5 + chitosan 0.4 to 0.6%, maintains its sensory quality until day 25, then loses sensory-flavor quality, ending with an acceptance of 5 by the panelists (neither like nor dislike it), being very close to the established acceptance limit of 4.5.

### Evaluation of the Texture of 5^{th} Range Artichoke Bottoms

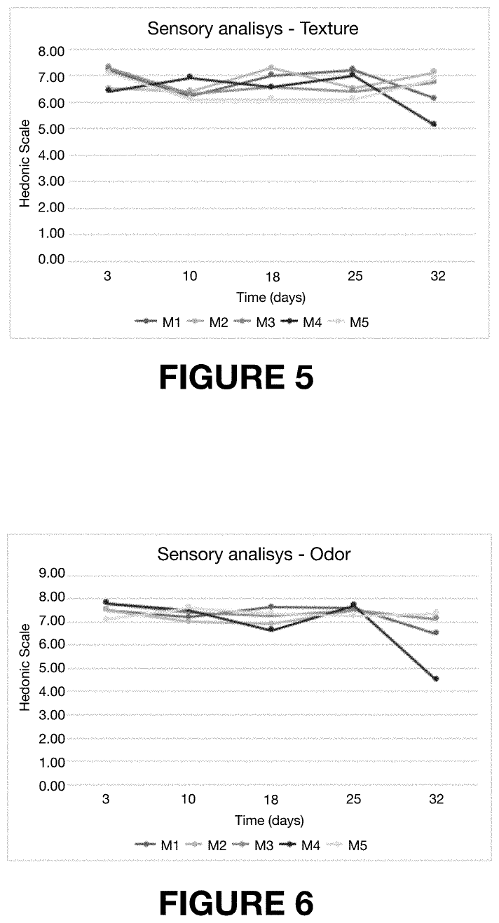

FIG. 5 shows the results obtained from the sensory—texture evaluation of the 5^{th} Range artichoke bottoms by means of a hedonic scale, it can be appreciated that there is a direct relationship between texture and flavor (see FIG. 4), therefore, if the texture of the artichoke is fibrous the characteristic flavor of the artichoke is distorted. On the other hand, the ready to eat treatments M1, M2, M3 and ready to use M5 did not show significant differences between treatments during the 32 days of sensory evaluation. While the ready to eat M4 treatment with edible coating: a mixture of a solution of 13-15% of ascorbic acid and calcium with ionic ratio ascorbate:calcium from 2:1 to 2:5.+chitosan 0.4 to 0.6%, maintains its sensory quality until day 25, then it loses sensory quality ending with an acceptance of 5 by the panelists (neither like nor dislike it) being very close to the established acceptance limit of 4.5.

### Evaluation of the Smell of 5^{th} Range Artichoke Bottoms

FIG. 6 shows the results obtained from the sensory—odor evaluation of the 5^{th} Range artichoke bottoms by means of a hedonic scale, the ready to eat treatments M1, M2, M3 and ready to use M5 did not present significant differences between treatments during the 32 days of sensory evaluation. While the ready-to-eat M4 treatment with edible coating: mixture of a solution of 13-15% of ascorbic acid and calcium with ionic ratio ascorbate:calcium from 2:1 to 2:5. +chitosan 0.4 to 0.6%, maintains its sensory quality until day 25, then loses sensory quality ending with an acceptance of 4.5 by the panelists being at the established acceptance limit.

### Example 2. 5^{th} Range Artichoke Test, No Cold Chain Interruption (November 2019)

The shelf life assessment test was performed for 30 days, at a storage temperature of between 1 to 3° C. without cold chain interruption.

Design: Table 3 shows the treatments design for testing without cold chain interruption. Treatments M1 to M4 correspond to ready to eat artichoke, while the M0 treatment corresponds to ready to use artichoke.

TABLE 3
Uninterrupted cold chain test.

| | | | | First | Second | | | | |
|---|---|---|---|---|---|---|---|---|---|
| | | | | Immersion | Immersion | Cooking | | Edible Coating | |
| | No | Bag | | (T = ~20° C., | (T = ~20° C., | (T = ~100° | Hydrocooling | (T = ~2-3° C., | |
| Sample | bottoms | number | Field | tmin = ~5′) | tmin = ~5′) | C.) | (T = ~3-5° C.) | t = ~3′) | Packaging |
| M1 | 60 | 20 | A | Citric acid | Citric acid | t = 11′ | Citric Acid | Sol. 13-15% of | Active |
| | | | | 0.8-1.2% | 0.4-0.6%, | | 0.1-0.3%, | Ascorbic Acid | modified |
| | | | | and | Ascorbic | | Ascorbic Acid | and calcium, | atmospheres |
| | | | | Ascorbic | Acid 0.2- | | 0.08-0.12% | Ascorb:Ca ion | |
| | | | | Acid 0.4- | 0.3% and | | and sodium | ratio from 2:1 | |
| | | | | 0.6% | sodium | | chloride 0.2- | to 2:5. | |
| M2 | 60 | 20 | A | | chloride | | 0.4% | Sol. mixture | |
| | | | | | 0.65-0.85% | | | 13-15% | |
| | | | | | | | | Ascorbic Ac. | |
| | | | | | | | | and calcium, | |
| | | | | | | | | Ascorb:Ca ion | |
| | | | | | | | | ratio from 2:1 | |
| | | | | | | | | to 2:5 + | |
| | | | | | | | | chitosan 0.4 to | |
| | | | | | | | | 0.6% | |
| M3 | 90 | 30 | B | | | | | Sol. 13-15% | |
| | | | | | | | | Ascorbic Ac. | |
| | | | | | | | | and calcium, | |
| | | | | | | | | Ascorb:Ca ion | |
| | | | | | | | | ratio from 2:1 | |
| | | | | | | | | to 2:5. | |
| M4 | 90 | 30 | B | | | | | Sol. mixture | |
| | | | | | | | | 13-15% | |
| | | | | | | | | Ascorbic Ac. | |
| | | | | | | | | and calcium, | |
| | | | | | | | | Ascorb:Ca ion | |
| | | | | | | | | ratio from 2:1 | |
| | | | | | | | | to 2:5. + | |
| | | | | | | | | chitosan 0.4 to | |
| | | | | | | | | 0.6% | |
| M0 | 21 | 7 | B | | | t = 5′ | | Sol. 13-15% | |
| | | | | | | | | Ascorbic Ac. | |
| | | | | | | | | and calcium, | |
| | | | | | | | | Ascorb:Ca ion | |
| | | | | | | | | ratio from 2:1 | |
| | | | | | | | | to 2:5. | |

T: temperature, t = time

### Results

### Raw Material

Raw material (artichoke) Field A: Artichokes coming from Field A have an equatorial diameter of about 10.00 cm, being unable to perform the destructive physical-chemical analysis (pH, % Salt, titratable acidity and ° Brix) due to the low availability of raw material. Regarding the microbiological analysis, they have an average of 49×10⁴ Cfu/g of mesophilic aerobes, 71×10³ Cfu/g of Coliforms, 18×10³ Cfu/g of Molds and 56×10³ Cfu/g of Yeasts.
Raw material (artichoke) Field B: Artichokes from Field B have an equatorial diameter of 8.89 cm, pH 6.33, 0.10% sodium chloride, 0.16% titratable acidity and 9 ° Brix, field B meets all established physical-chemical parameters. Regarding the microbiological analysis, they have an average of 16×10⁴ Cfu/g of mesophilic aerobes, 47×10² Cfu/g of Coliforms, 10×10² Cfu/g of Molds and 38×10² Cfu/g of Yeasts.

In addition, the microbiological parameters for both fields are within the limits allowed by the Peruvian regulations.

### Visual Appearance of the Bags

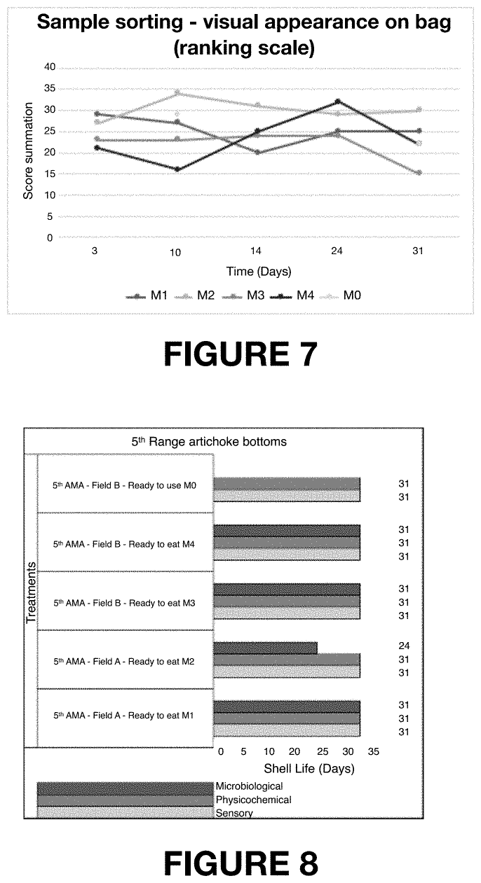

FIG. 7 shows the results obtained from the evaluation of the visual appearance of a bag of 5^{th} Range artichoke bottoms by means of a ranking order, on day 31, the ready to eat treatments M1 and M2 showed a better visual appearance followed by the M4 treatment and the ready to use M0 treatment. While the ready to eat M3 treatment is losing visual quality over time.

### Shelf Life of 5^{th} Range Artichoke Bottoms

FIG. 8 shows the results obtained from the sensory evaluation of 5^{th} Range artichoke bottoms by means of a hedonic scale, all the ready to eat M1, M3 and M4 treatments reached 32 days of shelf life in all parameters evaluated: physical-chemical, microbiological and sensory.

As for the ready-to-eat M2 treatment, 31 days were reached for sensory and physical-chemical parameters and 24 days for microbiological parameters. Likewise, the microbiological analysis to the ready to use M0 treatment was only performed on day 31, having abnormal values, however, this treatment reached 31 days in the physical-chemical and sensorial parameters.

### Color Assessment of the 5^{th} Range Artichoke Bottoms

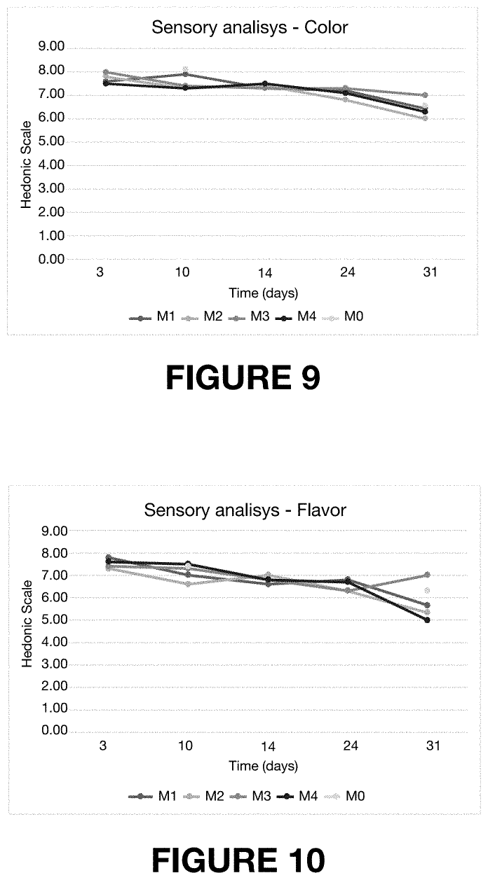

FIG. 9 shows the results obtained from the sensory—color evaluation of the 5^{th} Range artichoke bottoms by means of a hedonic scale, all the ready to eat treatments M1, M2, M3 and M4 and ready to use M0 did not show significant differences between treatments during the 32 days of sensory evaluation.

### Taste Assessment of 5^{th} Range Artichoke Bottoms

FIG. 10 shows the results obtained from the sensory—flavor evaluation of the 5^{th} Range artichoke bottoms by means of a hedonic scale, the ready to eat treatments M1, M2, M3, M4 and ready to use M0 loose sensory—taste quality without significant differences between treatments during the 24 days of sensory evaluation. On day 31, samples of the M0, M1 and M2 treatments did not present significant differences between treatments, while the ready-to-eat M4 treatment with edible coating: mixture of a solution of 13-15% of ascorbic acid and calcium with ionic ratio ascorbate:calcium from 2:1 to 2:5 +chitosan 0.4 to 0.6%, loses sensory-flavor quality, ending up with an acceptance of 5 by the panelists (neither like nor dislike it), being very close to the established acceptance limit of 4.5.

### Evaluation of the Texture of 5^{th} Range Artichoke Bottoms

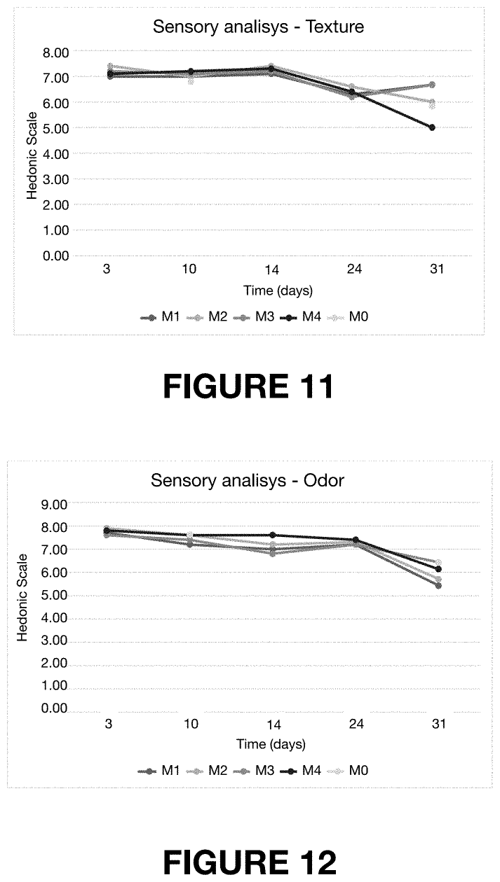

FIG. 11 shows the results obtained from the sensory—texture evaluation of the 5^{th} Range artichoke bottoms by means of a hedonic scale, it can be appreciated that there is a direct relationship between texture and flavor (see FIG. 10), therefore, if the texture of the artichoke is fibrous the characteristic flavor of the artichoke is distorted. On the other hand, the ready to eat treatments M1, M2, M3 and ready to use M0 lose sensory—texture quality and did not show significant differences between treatments during the 31 days of sensory evaluation. While the ready-to-eat treatment M4 with edible coating: mixture of a solution of 13-15% of ascorbic acid and calcium with ionic ratio ascorbate:calcium from 2:1 to 2:5 +chitosan 0.4 to 0.6%, lose sensory quality ending with an acceptance of 5 by the panelists (neither like nor dislike it) being very close to the established acceptance limit of 4.5.

### Evaluation of the Smell of 5^{th} Range Artichoke Bottoms

FIG. 12 shows the results obtained from the sensory—odor evaluation of the 5^{th} Range artichoke bottoms by means of a hedonic scale, the ready to eat treatments M1, M2, M3, M4 and ready to use M0 lose sensory-texture quality and did not show significant differences between treatments during the 31 days of sensory evaluation.

### Example 3. 5^{th} Range Artichoke Test, No Cold Chain Interruption (December 2019)

The shelf life assessment test was performed for 30 days, at a storage temperature of between 1 to 3° C. without cold chain interruption.

Design: Table 4 shows the treatments design for testing without cold chain interruption. Treatments M1 to M4 correspond to ready to eat artichoke, while treatments M5 and M6 correspond to ready to use artichoke.

TABLE 4
Uninterrupted cold chain test.

| | | | | First | Second | | | | |
|---|---|---|---|---|---|---|---|---|---|
| | | | | Immersion | Immersion | Cooking | | Edible Coating | |
| | No | Bag | | (T = ~20° C., | (T = ~20° C., | (T = ~100° | Hydrocooling | (T = ~2-3° C., | |
| Sample | bottoms | number | Field | tmin = ~5′) | tmin = ~5′) | C.) | (T = ~3-5° C.) | t = ~3′) | Packaging |
| M1 | 90 | 30 | A | Citric Acid | Citric acid | t = 11′ | Citric acid | Sol. 13-15% of | Active |
| | | | | 0.8-1.2% | 0.4-0.6%, | | 0.1-0.3%, | Ascorbic Acid | modified |
| | | | | and | Ascorbic | | Ascorbic Acid | and calcium, | atmospheres |
| | | | | Ascorbic | Acid 0.2- | | 0.08-0.12% | Ascorb:Ca ion | (AMA) |
| | | | | Acid 0.4- | 0.3% and | | and sodium | ratio from 2:1 | |
| | | | | 0.6% | sodium | | chloride 0.2- | to 2:5. | |
| M2 | 90 | 30 | A | | chloride | | 0.4% | Sol. mixture | |
| | | | | | 0.65-0.85% | | | 13-15% | |
| | | | | | | | | Ascorbic Ac. | |
| | | | | | | | | and calcium, | |
| | | | | | | | | Ascorb:Ca ion | |
| | | | | | | | | ratio from 2:1 | |
| | | | | | | | | to 2:5 + | |
| | | | | | | | | chitosan 0.4 to | |
| | | | | | | | | 0.6% | |
| M3 | 90 | 30 | B | | | | | Sol. 13-15% | |
| | | | | | | | | Ascorbic Ac. | |
| | | | | | | | | and calcium, | |
| | | | | | | | | Ascorb:Ca ion | |
| | | | | | | | | ratio from 2:1 | |
| | | | | | | | | to 2:5. | |
| M4 | 90 | 30 | B | | | | | Sol. mixture | |
| | | | | | | | | 13-15% | |
| | | | | | | | | Ascorbic Ac. | |
| | | | | | | | | and calcium, | |
| | | | | | | | | Ascorb:Ca ion | |
| | | | | | | | | ratio from 2:1 | |
| | | | | | | | | to 2:5. + | |
| | | | | | | | | chitosan 0.4 to | |
| | | | | | | | | 0.6% | |
| M5 | 90 | 30 | B | | | t = 5′ | | Sol. mixture | |
| | | | | | | | | 13-15% [symbol] | |
| | | | | | | | | Ascorbic Acid | |
| | | | | | | | | and calcium, | |
| | | | | | | | | Ascorb:Ca ion | |
| | | | | | | | | ratio from 2:1 | |
| | | | | | | | | to 2:5. + | |
| | | | | | | | | chitosan 0.4 to | |
| | | | | | | | | 0.6% | |
| M6 | 90 | 30 | B | | | | | Sol. 13-15% | |
| | | | | | | | | Ascorbic Ac. | |
| | | | | | | | | and calcium, | |
| | | | | | | | | Ascorb:Ca ion | |
| | | | | | | | | ratio from 2:1 | |
| | | | | | | | | to 2:5. | |

T: temperature, t = time

### Results

### Raw Material

Raw material (artichoke) Field A: Artichokes coming from Field A have an equatorial diameter of about 8.24 cm, pH 6.29, 0.10% sodium chloride, 0.13% titrable acidity and 11° Brix, field A meets all established physical-chemical parameters. Regarding the microbiological analyses, they have on average, 25×10⁵ Cfu/g of mesophilic aerobes, 21×10⁵ Cfu/g of Coliforms, 35×10² Cfu/g of Molds and 11×10⁴ Cfu/g of Yeasts.
Raw material (artichoke) Field B: Artichokes from Field B have an equatorial diameter of 8.35 cm, pH 6.55, 0.10% Salt, 0.10% titrable acidity and 4° Brix, a brix lower than stipulated for the raw material is presented. Regarding the microbiological analyses, they have on average 22×10⁵ Cfu/g of mesophilic aerobes, 40×10⁴ Cfu/g of Coliforms, 30×10² Cfu/g of Molds and 12×10³ Cfu/g of Yeasts.

### Visual Appearance of Bags

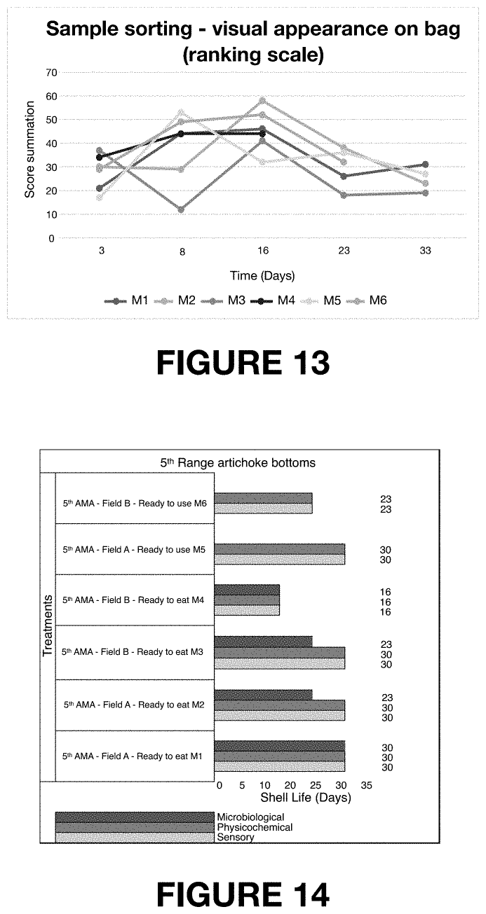

FIG. 13 shows the results obtained from the evaluation of the visual appearance of a bag of 5^{th} Range artichoke bottoms by means of a ranking order, on day 31, treatments M1 and M5 showed a better visual appearance followed by treatment M2 and treatment M3. While the M4 treatment was evaluated up to day 16 due to microbial growth problems in the artichoke bottoms, as well as in the M6 treatment the presence of colonies in the bottoms arises on day 23, the last day of evaluation.

### Shelf Life of 5^{th} Range Artichoke Bottoms

FIG. 14 reports the results obtained from the sensory, physical-chemical and microbiological evaluation carried out for 30 days to the 5^{th} Range artichoke bottoms. The M1 treatment reached 30 days of shelf life in all the evaluated parameters: physical-chemical, microbiological and sensory. The Ready to eat treatments M2 and M3 reached 30 days of shelf life in the physical-chemical and sensorial parameters, while in the microbiological parameter they reached 23 days of shelf life. The Ready to eat treatment M4 reached 16 days of shelf life in all the evaluated parameters: physical-chemical, microbiological and sensory. On the other hand, only physical-chemical and sensory analyses were carried out in the ready to use treatments M5 reaching 30 days, while the ready to use treatment M6 reached 23 days because it showed growth of colonies on the surface of the bottoms.

### Color Assessment of the 5^{th} Range Artichoke Bottoms

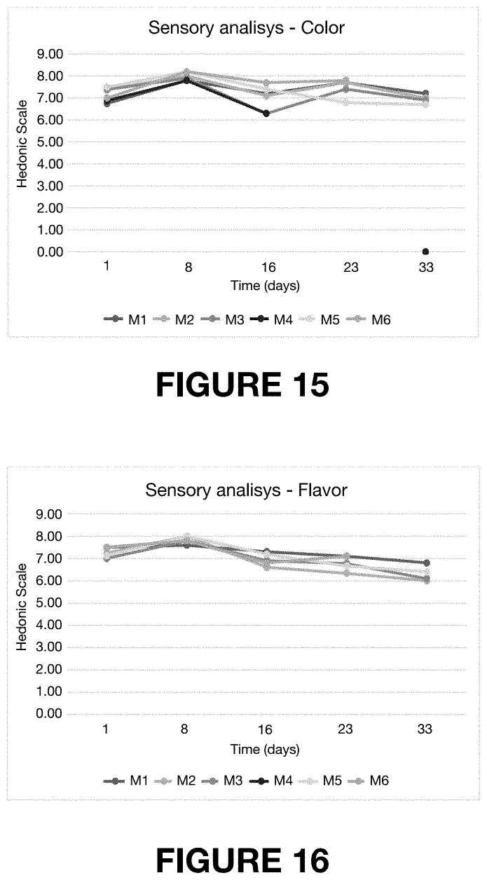

FIG. 15 shows the results obtained from the sensory—color evaluation of the 5^{th} Range artichoke bottoms by means of a hedonic scale, all the ready to eat treatments M1, M2 and M3, and ready to use M5 did not show significant differences between treatments during the 30 days of sensory evaluation maintaining their sensory-color quality. While the ready to eat M4 and ready to use M6 treatments were only analyzed until they showed the presence of colonies on the surface of the artichoke bottoms on day 16 for M4 and day 23 for M6.

### Taste Assessment of 5^{th} Range Artichoke Bottoms

FIG. 16 shows the results obtained from the sensory—flavor evaluation of the 5^{th} Range artichoke bottoms by means of a hedonic scale, the ready to eat treatments Ml, M2 and M3 and ready to use M5 lose sensory-flavor quality without showing significant differences between treatments during 30 days of sensory evaluation. The ready to eat M4 and ready to use M6 treatments in field B were only analyzed until they showed the presence of colonies on the surface of the artichoke bottoms on day 16 for M4 and on day 23 for M6.

### Evaluation of the Texture of 5^{th} Range Artichoke Bottoms

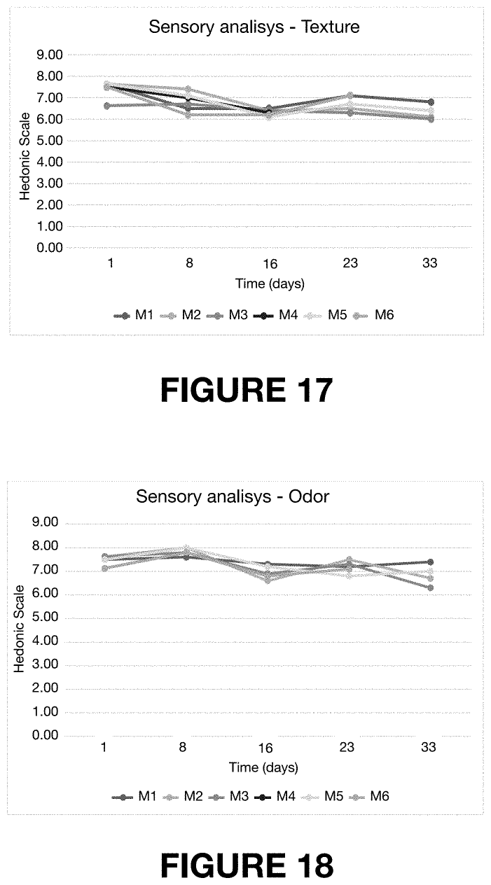

FIG. 17 shows the results obtained from the sensory—texture evaluation of the 5th Range artichoke bottoms by means of a hedonic scale, it can be appreciated that there is a direct relationship between texture and flavor, therefore, if the texture of the artichoke is fibrous the characteristic flavor of the artichoke is distorted. On the other hand, the ready to eat treatments M1, M2, M3 and ready to use M5 lose sensory—texture quality and did not show significant differences between treatments during the 30 days of sensory evaluation. On the other hand, the ready to eat treatments M4 and ready to use M6 were only analyzed until they showed the presence of colonies on the surface of artichoke bottoms on day 16 for M4 and on day 23 for M6.

### Evaluation of the Smell of 5^{th} Range Artichoke Bottoms

FIG. 18 shows the results obtained from the sensory—odor evaluation of the 5^{th} Range artichoke bottoms by means of a hedonic scale, the ready to eat treatments M1, M2 and M3 and ready to use M5 lose sensory-odor quality and did not show significant differences between treatments during the 30 days of sensory evaluation. However, the ready to eat M4 and ready to use M6 treatments were only analyzed until they showed the presence of colonies on the surface of the artichoke bottoms on day 16 for M4 and on day 23 for M6.

### Example 4. 5^{th} Range Artichoke Test, No Cold Chain Interruption (January 2020)

The shelf life assessment test was performed for 30 days, at a storage temperature of between 1 to 3° C. without cold chain interruption.

Design: Table 5 shows the treatments design for testing without cold chain interruption. Treatments M1 to M4 correspond to ready to eat artichoke, while the M5 and M6 treatments correspond to ready to use artichoke.

TABLE 5
Uninterrupted cold chain test.

| | | | | First | Second | | | | |
|---|---|---|---|---|---|---|---|---|---|
| | | | | Immersion | Immersion | Cooking | | Edible Coating | |
| | No | Bag | | (T = ~20° C., | (T = ~20° C., | (T = ~100° | Hydrocooling | (T = ~2-3° C., | |
| Sample | bottoms | number | Field | tmin = ~5′) | tmin = ~5′) | C.) | (T = ~3-5° C.) | t = ~3′) | Packaging |
| M1 | 90 | 30 | A | Citric Acid | Citric acid | t = 11′ | Citric acid | Sol. 13-15% of | Active |
| | | | | 0.8-1.2% | 0.4-0.6%, | | 0.1-0.3%, | Ascorbic Acid | Modified |
| | | | | and | Ascorbic | | Ascorbic Acid | and calcium, | Atmospheres |
| | | | | Ascorbic | Acid 0.2- | | 0.08-0.12% | Ascorb:Ca ion | (AMA) |
| | | | | Acid 0.4- | 0.3% and | | and sodium | ratio from 2:1 | |
| | | | | 0.6% | Sodium | | chloride 0.2- | to 2:5. | |
| M2 | 90 | 30 | A | | Chloride | | 0.4% | Sol. mixture | |
| | | | | | 0.65-0.85% | | | 13-15% | |
| | | | | | | | | Ascorbic Ac. | |
| | | | | | | | | and calcium, | |
| | | | | | | | | Ascorb:Ca ion | |
| | | | | | | | | ratio from 2:1 | |
| | | | | | | | | to 2:5 + | |
| | | | | | | | | chitosan 0.4 to | |
| | | | | | | | | 0.6% | |
| M3 | 90 | 30 | B | | | | | Sol. 13-15% | |
| | | | | | | | | Ascorbic Ac. | |
| | | | | | | | | and calcium, | |
| | | | | | | | | Ascorb:Ca ion | |
| | | | | | | | | ratio from 2:1 | |
| | | | | | | | | to 2:5. | |
| M4 | 90 | 30 | B | | | | | Sol. mixture | |
| | | | | | | | | 13-15% | |
| | | | | | | | | Ascorbic Ac. | |
| | | | | | | | | and calcium, | |
| | | | | | | | | Ascorb:Ca ion | |
| | | | | | | | | ratio from 2:1 | |
| | | | | | | | | to 2:5. + | |
| | | | | | | | | chitosan 0.4 to | |
| | | | | | | | | 0.6% | |
| M5 | 90 | 30 | B | | | t = 5′ | | Sol. mixture | |
| | | | | | | | | 13-15% | |
| | | | | | | | | Ascorbic Ac. | |
| | | | | | | | | and calcium, | |
| | | | | | | | | Ascorb:Ca ion | |
| | | | | | | | | ratio from 2:1 | |
| | | | | | | | | to 2:5. + | |
| | | | | | | | | chitosan 0.4 to | |
| | | | | | | | | 0.6% | |
| M6 | 90 | 30 | B | | | | | Sol. 13-15% | |
| | | | | | | | | Ascorbic Ac. | |
| | | | | | | | | and calcium, | |
| | | | | | | | | Ascorb:Ca ion | |
| | | | | | | | | ratio from 2:1 | |
| | | | | | | | | to 2:5. | |

T: temperature, t = time

### Results

### Raw Material

Raw material (artichoke) Field A: Artichokes coming from Field A have an equatorial diameter of 7.27 cm, pH 6.48, 0.29% Salt, 0.32% titrable acidity and 19.7° Brix, field A meets all the established physical-chemical parameters. Regarding the microbiological analyses, they have on average, 11×10⁵ Cfu/g of mesophile aerobes, 49×10⁴ Cfu/g of Coliforms, 23×10³ Cfu/g of Molds and 20×10³ Cfu/g of Yeasts.
Raw material (artichoke) Field B: Artichokes from Field B have an equatorial diameter of 7.36 cm, pH 6.61, 0.33% Salt, 0.16% titrable acidity and 16.7° Brix, field B meets all the established physical-chemical parameters. Regarding the microbiological analyses, they have on average 44×10⁵ Cfu/g of mesophilic aerobes, 13×10⁶ Cfu/g of Coliforms, 35×10⁴ Cfu/g of Molds and 29×10⁴ Cfu/g of Yeasts.

The microbiological parameters for both fields are within the limits allowed by Peruvian regulations.

### Visual Appearance of Bags

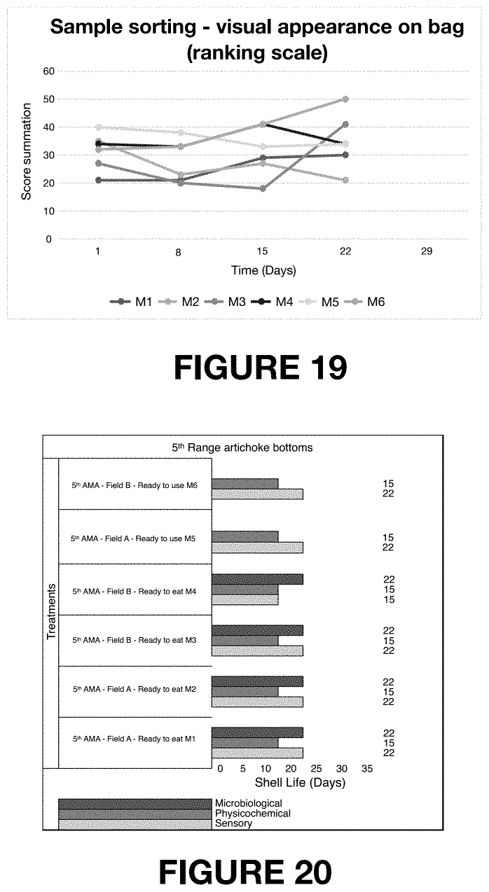

FIG. 19 shows the results obtained from the evaluation of the visual appearance of a bag of 5^{th} Range artichoke bottoms by means of a ranking order, during the 22 days of evaluation, the ready to use treatments M5 and M6 showed better visual appearance. The ready to eat treatment M4 has a good visual appearance, however, some samples of this treatment showed microbial growth, so it was only used for the visual appearance analysis and was discarded for the sensory analysis.

### Shelf Life of 5^{th} Range Artichoke Bottoms

FIG. 20 reports the results obtained from the sensory, physical-chemical and microbiological evaluation carried out for 30 days on the 5^{th} Range artichoke bottoms. The ready to eat treatments M1, M2 and M3 reached 22 days of shelf life in the microbiological and sensory parameters, while the physical-chemical parameters reached 15 days. The Ready to eat treatments M4 reached 22 days in the microbiological parameters (showed colony growth on the surface of the artichoke bottoms), reached 15 days in the physical-chemical parameters (the pH decreased and the percentage of acidity increased) and sensory parameters (no sensory evaluation was carried out after day 22). On the other hand, only physical-chemical and sensory analysis were carried out in the ready to use treatments M5 and M6, reaching 22 days in the sensory analysis and 15 days in the physical-chemical analysis.

### Color Assessment of the 5^{th} Range Artichoke Bottoms

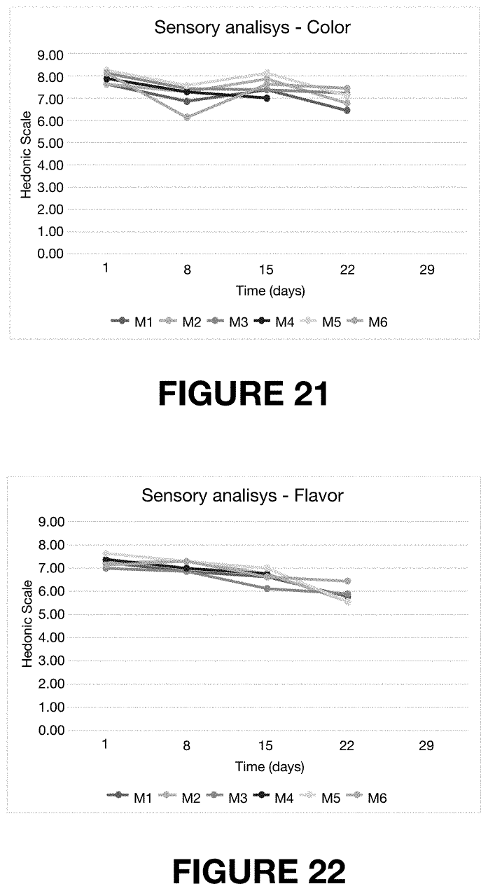

FIG. 21 shows the results obtained from the sensory—color evaluation of the 5^{th} Range artichoke bottoms by means of a hedonic scale, all the ready to eat treatments M1, M2 and M3 and ready to use M5 and M6 did not show significant differences between treatments during the 22 days of sensory evaluation maintaining their sensory-color quality. The M4 treatment was only analyzed until day 15, because on day 22 it showed colony growth on the surface of the artichoke bottoms. Sensory evaluations were not performed on all treatments on day 30 because of microbial growth on the surface of the bottoms in all samples.

### Taste Assessment of 5^{th} Range Artichoke Bottoms

FIG. 22 shows the results obtained from the sensory—flavor evaluation of the 5^{th} Range bottoms by means of a hedonic scale, the ready to eat treatments M1, M2 and

M3 and ready to use M5 and M6 lose sensory-flavor quality without showing significant differences between treatments during 22 days of sensory evaluation. The ready to eat treatment M4 was only analyzed until day 15, because on day 22 it showed colony growth on the surface of the artichoke bottoms. Sensory evaluations were not performed in all treatments on day 30 because of microbial growth on the surface of the bottoms in all samples.

### Evaluation of the Texture of 5^{th} Range Artichoke Bottoms

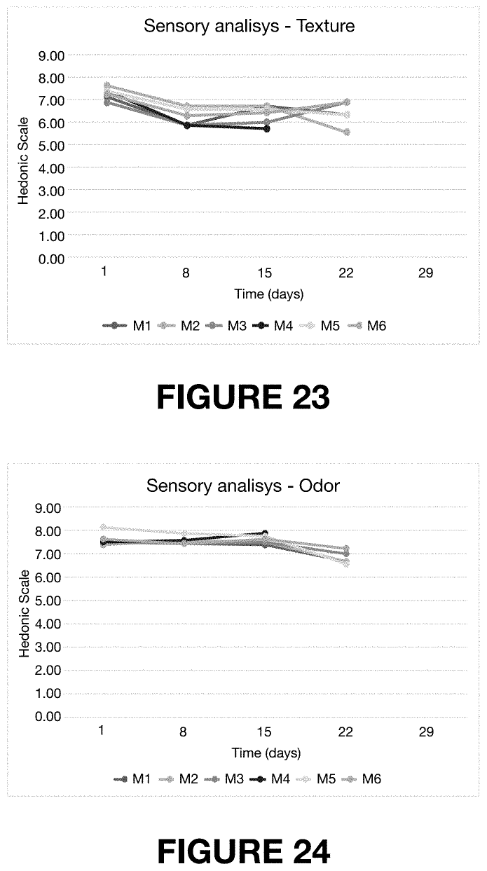

FIG. 23 shows the results obtained from the sensory—texture evaluation of the 5^{th} Range artichoke bottoms by means of a hedonic scale, it can be appreciated that there is a direct relationship between texture and flavor, therefore, if the texture of the artichoke is fibrous the characteristic flavor of the artichoke is distorted. On the other hand, the ready to eat treatments M1, M2 and M3 and ready to use M5 and M6 lose sensory-texture quality and did not show significant differences between treatments during the 22 days of sensory evaluation. On the other hand, the ready to eat treatment M4 was only analyzed until day 15, because on day 22 it showed colony growth on the surface of the artichoke bottoms. Sensory evaluations were not performed on all treatments on day 30 because of microbial growth on the surface of the bottoms in all samples.

### Evaluation of the Smell of 5^{th} Range Artichoke Bottoms

FIG. 24 shows the results obtained from the sensory—odor evaluation of the 5^{th} Range artichoke bottoms by means of a hedonic scale, the ready to eat treatments M1, M2 and M3 and ready to use M5 and M6 lose sensory-odor quality and did not show significant differences between treatments during the 22 days of sensory evaluation. However, the ready to eat treatment M4 was only analyzed until day 15, because on day 22 it showed colony growth on the surface of the artichoke bottoms. Sensory evaluations were not performed on all treatments on day 30 because of microbial growth on the surface of the bottoms in all samples

### Example 5. 5^{th} Range Artichoke Test, with Cold Chain Interruption (September 2018)

The shelf life of 5^{th} Range artichoke bottoms for export is evaluated by simulating the conditions of air transport, where one or more interruptions in the cold chain are produced, regularly occurring after 4 days (12 to 24 hours) of being processed and a possible second interruption on the 18^{th} day, simulating the temperature and time that can occur from purchase to consumption.

Evaluations to the product were made within the objective of reaching 30 days of shelf life stored in refrigeration from 1 to 3° C. producing 3 storage conditions: no interruption, 1 interruption and 2 interruptions of cold chain.

### Interruptions

M₇ and M₁₀: No cold chain interruption.

M₈ and M₁₁: Cold chain interruption day 4 for 24 hours

M₉ and M₁₂: Cold chain interruptions day 4 and 18 for 24 hours

### Experimental Design

TABLE 6
Interrupted cold chain test.

| | | First | Second | Cooking | | | |
|---|---|---|---|---|---|---|---|
| | | Immersion | Immersion | (T = ~100° | | Edible Coating | |
| | Bag | (T = ~20° C., | (T = ~20° C., | C., t = | Hydrocooling | (T = ~2-3° C., | |
| Sample | number | tmin = ~5′) | tmin = ~10′) | ~3′-3.2′) | (T = ~10-15° C.) | t = ~3′) | Packaging |
| M7 | 35 | Citric Acid 0.8- | Sol. 1-4% of | Citric acid | Water | chitosan 0.5 to 1.5% | Vacuum |
| M8 | 32 | 1.2% and | Ascorbic Acid | 0.1-0.3%, | | | Packaging (VP) |
| M9 | 20 | Ascorbic Acid | and calcium, | Ascorbic | | | |
| M10 | 35 | 0.4-0.6% | Ascorb:Ca ion | Acid 0.08- | | | Active |
| M11 | 32 | | ratio from 2:1 to | 0.12% | | | Modified |
| M12 | 20 | | 2:5. | and | | | Atmospheres |
| | | | | sodium | | | (AMA) |
| | | | | chloride | | | |
| | | | | 0.2-0.4% | | | |

T: temperature, t = time, t min = minimum time, each bag has 3 bottoms

TABLE 7
Cold chain interruptions.

| | Evaluation days** | | | | | | | | | | | | | | |
|---|---|---|---|---|---|---|---|---|---|---|---|---|---|---|---|
| | 1 | 2 | | | | | | | | | | | | | |
| | 7- | 8- | 3 | 4 | 5 | 6 | 7 | 8 | 9 | 10 | 11 | 12 | 13 | 14 | 15 |
| Sample | Sept | Sept | 9-Sept | 10-Sept | 11-Sept | 12-Sept | 13-Sept | 14-Sept | 15-Sept | 16-Sept | 17-Sept | 18-Sept | 19-Sept | 20-Sept | 21-Sept |
| M₇ | X | | | | | X | | | | | X | | X | | |
| M₈ | | | | ◯ | | | X | | X | | | X | | | X |
| M₉ | | | | ◯ | | | | | | | | | | | |
| M₁₀ | X | | | | | X | | | | | X | | X | | |
| M₁₁ | | | | ◯ | | | X | | X | | | X | | | X |
| M₁₂ | | | | ◯ | | | | | | | | | | | |
| | Evaluation days** | | | | | | | | | | | | | | |
| | 16 | 17 | | | | | | | | | | | | | |
| | 22- | 23- | 18 | 19 | 20 | 21 | 22 | 23 | 24 | 25 | 26 | 27 | 28 | 29 | 30 |
| Sample | Sept | Sept | 24-Sept | 25-Sept | 26-Sept | 27-Sept | 28-Sept | 29-Sept | 30-Sept | 1-Oct | 2-Oct | 3-Oct | 4-Oct | 5-Oct | 6-Oct |
| M₇ | X | | | X | | | X | | | X | | | X | | X |
| M₈ | | | X | | | X | | | X | | | X | | | X |
| M₉ | | | ◯ | | X | | | X | | | X | | X | | X |
| M₁₀ | X | | | X | | | X | | | X | | | X | | X |
| M₁₁ | | | X | | | X | | | X | | | X | | | X |
| M₁₂ | | | ◯ | | X | | | X | | | X | | X | | X |

◯ = Cold Interruption; X = evaluation

The 5^{th} RANGE—AMA (Active Modified Atmospheres) treatment of artichoke bottoms in their 3 storage conditions, without interruption M10, one interruption M11 and two interruptions M12 of the cold chain) using a mixture of citric and ascorbic acid (first immersion), a mixture of a solution of 1-4% of ascorbic acid and calcium with ionic ratio ascorbate:calcium from 2:1 to 2:5 (second immersion) a mixture of citric acid, ascorbic acid and sodium chloride for scalding (blanching), chitosan solution or chitosan at 0.5-1.5% (edible coating) and packaged with an injection of 50-70% gas mixture (2 to 6% O₂, 8 to 12% CO₂, and 82 to 90% N₂) in a flexible bag with a thickness of 100 microns; reached the 30 day goal only in the physical-chemical (pH and gross weight loss) and microbiological parameters (microbiological criteria of the “ready to eat”—5^{th} Range category), as far as the sensory parameters (values higher than 4.5) it was possible to reach 22 days for uncooked samples and 30 days for cooked samples.

The 5^{th} RANGE—VP (Vacuum Packing) treatment of artichoke bottoms in their 3 storage conditions, without interruption M7, one interruption M8 and two interruptions M9 of the cold chain using a mixture of citric and ascorbic acid (first immersion), a mixture of a solution of 1-4% of ascorbic acid and calcium with ascorbate:calcium ionic ratio of 2:1 to 2:5 (second immersion), mixture of citric acid, ascorbic acid and salt for scalding (blanching), 1% chitosan solution (edible coating) and vacuum packed in a 70 microns thick flexible bag; reached the 30 day target only in the physical-chemical (pH and gross weight loss) and microbiological parameters (microbiological criteria of the “ready to eat”—5^{th} Range category), as far as sensory parameters (values higher than 4.5) 7 days were reached for uncooked and cooked samples.

### Example 6. 5^{th} Range Artichoke Test, with Cold Chain Interruption (November 2018)

The shelf life of 5^{th} Range artichoke bottoms for export is evaluated by simulating the conditions of air transport, where one or more interruptions in the cold chain are produced, occurring regularly after 4 days (of 16 hours) of being processed and a possible second interruption on the 18^{th} day (of 6 hours), simulating the temperature and time that can occur from purchase to consumption.

Product evaluations were made within the objective of reaching 30 days of shelf life stored in refrigeration from 1 to 3° C. providing 3 storage conditions: no interruption, 1 interruption and 2 interruptions of cold chain.

### Interruptions

M₁₀, M₁₃ and M₁₆: No cold chain interruption.

M₁₁, M₁₄ and M₁₇: Cold chain interruption day 4 for 24 hours

M₁₂, M₁₅ and M₁₈: Cold chain interruption day 4 and 18 for 24 hours

### Experimental Design

TABLE 8
Interrupted cold chain test

| | | First | Second | Cooking- | | | |
|---|---|---|---|---|---|---|---|
| | | Immersion | Immersion | Blanching | Hydro- | | |
| | | (T = ~5-8° | (T = ~5-8° | (T = ~90- | cooling | | |
| | Bag | C., t min = | C., t min = | 95° C., t = | (T = | Edible Coating | |
| Sample | number | ~5′) | ~10′) | ~3′-3.2′) | ~3-5° C.) | (T = 2-3° C., t = ~2′) | Packaging |
| M10 | 26 | Citric Acid | Citric acid | Citric acid | Water | Sol. 13-15% Ascorbic | Active |
| M11 | 23 | 0.8-1.2% | 0.4-0.6%, | 0.1-0.3%, | | Ac. and calcium, | Modified |
| M12 | 19 | and | Ascorbic | Ascorbic | | ascorb:Ca ion ratio | Atmospheres |
| | | Ascorbic | Acid 0.2- | Acid 0.08- | | from 2:1 to 2:5. | (AMA) |
| M13 | 26 | Acid 0.4- | 0.3% and | 0.12% | | Citric acid 0.6%, | |
| M14 | 23 | 0.6% | sodium | and | | Ascorbic Acid 0.8% | |
| M15 | 19 | | chloride | sodium | | and chitosan 0.5-0.7% | |
| M16 | 26 | | 0.65- | chloride | | Sol. 13-15% Ascorbic | Passive |
| M17 | 23 | | 0.85% | 0.2-0.4% | | Ac. and calcium, | Modified |
| M18 | 19 | | | | | ascorb:Ca ion ratio | Atmospheres |
| | | | | | | from 2:1 to 2:5. | (PMA) |

T: temperature, t = time, t min = minimum time, each bag has 3 bottoms

TABLE 9
Cold chain interruptions.

| | Evaluation days** | | | | | | | | | | | | | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 |
| | 9- | 10- | 11- | 12- | 13- | 14- | 15- | 16- | 17- | 18- | 19- | 20- | 21- | 22- | 23- | 24- |
| Sample | Nov | Nov | Nov | Nov | Nov | Nov | Nov | Nov | Nov | Nov | Nov | Nov | Nov | Nov | Nov | Nov |
| M10 | X | | | | | | X | | | | | | X | | | |
| M11 | | | | ◯ | | X | | | | | | X | | | | |
| M12 | | | | ◯ | | | | | | | | | | | | |
| M13 | X | | | | | | X | | | | | | X | | | |
| M14 | | | | ◯ | | X | | | | | | X | | | | |
| M15 | | | | ◯ | | | | | | | | | | | | |
| M16 | X | | | | | | X | | | | | | X | | | |
| M17 | | | | ◯ | | X | | | | | | X | | | | |
| M18 | | | | ◯ | | | | | | | | | | | | |
| | Evaluation days** | | | | | | | | | | | | | | | |
| | 17 | 18 | 19 | 20 | 21 | 22 | 23 | 24 | 25 | 26 | 27 | 28 | 29 | 30 | 31 | 32 |
| Sample | 25-Nov | 26-Nov | 27-Nov | 28-Nov | 29-Nov | 30-Nov | 1-Dec | 2-Dec | 3-Dec | 4-Dec | 5-Dec | 6-Dec | 7-Dec | 8-Dec | 9-Dec | 10-Dec |
| M10 | | | X | | | | | | X | | | | | | | X |
| M11 | | X | | | | | | X | | | | | X | | | |
| M12 | | ◯ | | X | | | X | | | X | | | X | | | |
| M13 | | | X | | | | | | X | | | | | | | X |
| M14 | | X | | | | | | X | | | | | X | | | |
| M15 | | ◯ | | X | | | X | | | X | | | X | | | |
| M16 | | | X | | | | | | X | | | | | | | X |
| M17 | | X | | | | | | X | | | | | X | | | |
| M18 | | ◯ | | X | | | X | | | X | | | X | | | |

◯—Cold Interruption; X—evaluation

The 5^{th} RANGE—AMA treatment of artichoke bottoms in their 3 storage conditions, without interruption (M10), one interruption (M11) and two interruptions (M12) of the cold chain, using a mixture of citric and ascorbic acid (first immersion), a mixture of citric acid, ascorbic acid and sodium chloride (second immersion), a mixture of citric acid, ascorbic acid and sodium chloride for scalding (blanching), a mixture of a solution of 13-15% of ascorbic acid and calcium with an ascorbate:calcium ionic ratio from 2:1 to 2:5 (edible coating) and packaged with an injection of 50-70% of gas mixture (2-6% O₂, 8-12% CO₂ and 82-90% N₂) in a flexible bag with a thickness of 70 microns. The M10 treatment reached the goal of 30 days of shelf life in the physical-chemical and sensory parameters in uncooked and cooked samples; while the microbiological parameter was 18 days. As for the M11 and M12 treatments, they reached 19 days of shelf life in the microbiological and physical-chemical parameters, while in the sensory parameters both the uncooked and cooked samples of the M11 treatment reached 12 days. A sensorial evaluation was not carried out in the M12 treatment because the samples were discarded at the 19^{th} day together with the M11 samples due to microbiological problems of the raw material, which became evident in the finished product. According to the schedule, the evaluation should have been performed on the 19^{th} day.

The 5^{th} RANGE—AMA treatment of artichoke bottoms in its 3 storage conditions, without interruption (M13), one interruption (M14) and two interruptions (M15) of the cold chain, using a mixture of citric and ascorbic acid (first immersion), a mixture of citric, ascorbic acid and sodium chloride (second immersion), mixture of citric acid, ascorbic acid and sodium chloride for scalding (blanching), chitosan solution-Acids (edible coating) and packed with an injection of 50-70% gas mixture (2-6% O₂, 8-12% CO₂ and 82-90% N₂) in a flexible 70 micron thick bag; The M13 sample reached the goal of 30 days of shelf life in the physical-chemical and sensory parameters in uncooked and cooked samples; while the microbiological parameter was 18 days. As for the M14 samples, they reached 19 days of shelf life in the microbiological, physical-chemical and sensory parameters in both uncooked and cooked samples. The M15 samples reached 19 days of shelf life in the microbiological and physical-chemical parameters and no sensory evaluation was performed because the samples were discarded on the 19^{th} day together with the M14 samples due to microbiological problems of the raw material, which became evident in the finished product. According to the schedule, the evaluation should have been performed on the 19^{th} day.

The 5^{th} RANGE—AMP treatment of artichoke bottoms in their 3 storage conditions, without interruption (M16), one interruption (M17) and two interruptions (M18) of the cold chain, using a mixture of citric and ascorbic acid (first immersion), mixture of citric acid, ascorbic acid and sodium chloride (second immersion), mixture of citric acid, ascorbic acid and sodium chloride for scalding (blanching), 13-15% of ascorbic acid and calcium with an ascorbate:calcium ionic ratio from 2:1 to 2:5 (edible coating) and packaged in an Xtend bag with micro-perforations; the M16 treatment reached a 13-day shelf life for physical-chemical, microbiological and sensory parameters in uncooked and cooked samples. The M17 treatment reached a shelf life of 12 days in the physical-chemical and microbiological parameters, while in the sensory parameters it was 6 days in uncooked and cooked samples. As for the M18 treatment, no evaluation was carried out because the samples were discarded on the 13^{th} day together with the M17 samples due to microbiological problems of the raw material, which became evident in the finished product. According to the schedule, the evaluation should have been carried out on the 19^{th} day.

### Example 7. 5^{th} Range Artichoke Test, with Cold Chain Interruption (December 2018)

The shelf life of 5^{th} Range artichoke bottoms for export is evaluated by simulating the conditions of air transport, where one or more interruptions in the cold chain were produced, occurring regularly after 4 days (of 16 hours) of being processed and a possible second interruption on the 19^{th} day (of 6 hours), simulating the temperature and time that can occur from purchase to consumption.

Product evaluations were made within the objective of reaching 30 days of shelf life stored in refrigeration from 1 to 3° C. producing 3 storage conditions: no interruption, 1 interruption and 2 interruptions of cold chain.

### Interruptions

M₂, M₅ , M₆ and M₉: No cold chain interruption.

M₃ and M₇: Cold chain interruption at 4^{th} day (16 hours).

M₄ and M₈: 2 Cold chain interruptions at 4^{th} day (16 hours) and 19^{th} day (6 hours).

### Experimental Design

TABLE 10
Interrupted cold chain test.

| Packaging | | | | | | | |
|---|---|---|---|---|---|---|---|
| (gas | | | | | | | |
| mixture | | | | | | | |
| injection: 2 | | | | | | | |
| to 6% O₂, 8 | First | Second | | | Edible | | |
| to 12% | Immersion | Immersion | Blanching | | Coating | | |
| CO₂, and | (T = ~20° C., | (T = ~20° C., | (T = ~90-95° | | (T = ~2-3° | | |
| 82 to 90% | tmin = | tmin = ~5 | C., t = ~3.2 | Hydrocooling | C., t = ~3 | | |
| N₂) | ~5 min) | min) | min) | (T = ~3-5° C.) | min) | Treatment | Sample |
| Active | Citric Acid | Citric acid | Citric acid | Citric acid 0.1- | Sol. 13-15% | No | M₂ |
| Modified | 0.8-1.2% | 0.4-0.6%, | 0.1-0.3%, | 0.3%, | Ascorbic | Chitosan | M₃ |
| Atmospheres | and | Ascorbic | Ascorbic | Ascorbic Acid | Ac. and | | M₄ |
| (AMA) | Ascorbic | Acid 0.2- | Acid 0.08- | 0.08-0.12% | calcium, | | |
| | Acid 0.4- | 0.3% and | 0.12% and | and sodium | Ascorb:Ca | | |
| | 0.6% | sodium | sodium | Chloride 0.2- | ion ratio | | |
| | | chloride | Chloride | 0.4% | from 2:1 to | | |
| | | 0.65-0.85% | 0.2-0.4% | | 2:5. | | |
| | | | | | Chitosan | With | M₅ |
| | | | | | 0.4- | Chitosan | |
| | | | | | 0.8%//Citric | | |
| | | | | | ac. 0.4- | | |
| | | | | | 0.8%// | | |
| | | | | | Ascorbic | | |
| | | | | | ac. 0.6-1% | | |
| | | Sol. 5-7% | Citric acid | Citric acid 0.1- | Chitosan | With | M₆ |
| | | Ascorbic | 0.1-0.3%, | 0.3%, | 0.4- | Chitosan | M₇ |
| | | Ac. and | Ascorbic | Ascorbic Acid | 0.8%//Citric | | M₈ |
| | | calcium, | Acid 0.08- | 0.08-0.12% | ac. 0.4- | | |
| | | Ascorb:Ca | 0.12% and | and sodium | 0.8%// | | |
| | | ion ratio | sodium | chloride 0.2- | Ascorbic | | |
| | | from 2:1 to | chloride | 0.4% | ac. 0.6-1% | | |
| | | 2:5. | 0.2-0.4% | | | | |
| | | Sol. 4-8% | Citric acid | Citric acid 0.1- | Chitosan | With | M₉ |
| | | calcium | 0.1-0.3%, | 0.3%, | 0.4- | Chitosan | |
| | | ascorbate | Ascorbic | Ascorbic Acid | 0.8%//Citric | | |
| | | | Acid 0.08- | 0.08-0.12% | ac. 0.4- | | |
| | | | 0.12% and | and sodium | 0.8%// | | |
| | | | sodium | chloride 0.2- | Ascorbic | | |
| | | | chloride | 0.4% | ac. 0.6-1% | | |
| | | | 0.2-0.4% | | | | |

T: temperature, t = time, t min = minimum time, each bag has 3 bottoms.

TABLE 11
Cold chain interruptions.

| | Evaluation days** | | | | | | | | | | | | | | | |
|---|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 | 16 |
| | 15- | 16- | 17- | 18- | 19- | 20- | 21- | 22- | 23- | 24- | 25- | 26- | 27- | 28- | 29- | 30- |
| Sample | Dec | Dec | Dec | Dec | Dec | Dec | Dec | Dec | Dec | Dec | Dec | Dec | Dec | Dec | Dec | Dec |
| M2 | | | X | | | | X | | | | | | X | | | |
| M3 | | | | ◯ | X | | | | | | | X | | | | |
| M4 | | | | ◯ | | | | | | | | | | | | |
| M5 | | | X | | | | X | | | | | | X | | | |
| M6 | | | X | | | | X | | | | | | X | | | |
| M7 | | | | ◯ | X | | | | | | | X | | | | |
| M8 | | | | ◯ | | | | | | | | | | | | |
| M9 | | | X | | | | X | | | | | | X | | | |
| | Evaluation days** | | | | | | | | | | | | | | | |
| | | 17 | 18 | 19 | 20 | 21 | 22 | 23 | 24 | 25 | 26 | 27 | 28 | 29 | 30 | 31 |
| | | 31- | 1- | 2- | 3- | 4- | 5- | 6- | 7- | 8- | 9- | 10- | 11- | 12- | 13- | 14- |
| | Sample | Dec | Jan | Jan | Jan | Jan | Jan | Jan | Jan | Jan | Jan | Jan | Jan | Jan | Jan | Jan |
| | M2 | | | X | | | | | | X | | | | | | X |
| | M3 | | | | X | | | | X | | | | X | | | |
| | M4 | | | ◯ | X | | | | X | | | | X | | | |
| | M5 | | | X | | | | | | X | | | | | | X |
| | M6 | | | X | | | | | | X | | | | | | X |
| | M7 | | | | X | | | | X | | | | X | | | |
| | M8 | | | ◯ | X | | | | X | | | | X | | | |
| | M9 | | | X | | | | | | X | | | | | | X |

◯ = Cold Interruption; X = evaluation

The 5^{th} RANGE—AMA treatment of artichoke bottoms in their 3 storage conditions: no interruption (M2), one interruption (M3) and two interruptions (M4) of the cold chain; using a mixture of citric and ascorbic acid (first immersion), a mixture of citric, ascorbic acid and sodium chloride (second immersion), a mixture of citric, ascorbic acid and sodium chloride for scalding (blanching), a mixture of citric, ascorbic acid and sodium chloride (hydrocooling), 13-15% of ascorbic acid and calcium with an ascorbate:calcium ionic ratio from 2:1 to 2:5 (edible coating) and packaged with an injection of 50-70% of gas mixture (2-6% O₂, 8-12% CO₂ and 82-90% N₂) in a flexible bag of 70 microns thickness; AMA M2 samples reached the goal of 31 days of shelf life in all evaluated parameters (physical-chemical, microbiological and sensory) in uncooked and cooked samples. As for the AMA M3 and AMA M4 samples, they reached 28 days of shelf life in the physical-chemical and sensory parameters in both uncooked and cooked samples, while the microbiological parameter in the AMA 3 and AMA M4 samples reached 24 and 20 days of shelf life, respectively. This 5^{th} RANGE-AMA treatment started with an average sensory score of 6.73 in uncooked samples and 6.95 in cooked samples and ended with an average score of 5.83 in uncooked samples and 5.73 in cooked samples.

The V RANGE—AMA treatment of artichoke bottoms without interruption (M5); using a mixture of citric and ascorbic acid (first immersion), a mixture of citric, ascorbic acid and salt (second immersion), a mixture of citric, ascorbic acid and sodium chloride for scalding (blanching), a mixture of citric acid, ascorbic and sodium chloride (Hydrocooling), Chitosan/Acid solution (edible coating) and packed with an injection of 50-70% gas mixture (2-6% O₂, 8-12% CO₂ and 82-90% N₂) in a flexible 70 micron thick bag; the AMA M5 samples reached the target of 31 days of shelf life in all parameters evaluated: physical-chemical, microbiological and sensory, both in uncooked and cooked samples.

The 5^{th} RANGE—AMA treatment of artichoke bottoms in its 3 storage conditions: no interruption (M6), one interruption (M7) and two interruptions (M8) of the cold chain; using a mixture of citric and ascorbic acid (first immersion), 5-7% ascorbic acid and calcium with an ascorbate:calcium ionic ratio of 2:1 to 2:5 (second immersion), a mixture of citric acid, ascorbic acid and sodium chloride for scalding (blanching), Chitosan/Acids solution (edible coating) and packed with an injection of 50-70% of gas mixture (2-6% O₂, 8-12% CO₂ and 82-90% N₂) in a flexible 70 micron thick bag. The AMA M6 samples reached the 31-day shelf life goal in all evaluated parameters (physical-chemical, microbiological and sensory) in uncooked and cooked samples. As for the AMA M7 and AMA M8 samples, they reached 28 days of shelf life in the physical-chemical and sensory parameters, both in the uncooked and cooked samples, while the microbiological parameter in the AMA 7 and AMA M8 samples reached 24 and 20 days of shelf life, respectively. This 5^{th} RANGE—AMA treatment, started with an average sensory score of 6.95 in uncooked samples and 6.93 cooked samples, and ended with an average score of 6.33 in uncooked samples and 5.6 in cooked samples.

The 5^{th} RANGE—AMA treatment of artichoke bottoms without interruption (M9); using a mixture of citric and ascorbic acid (first immersion), solution of 4-8% of calcium ascorbate (second immersion), mixture of citric, ascorbic acid and sodium chloride for scalding (blanching), mixture of citric acid ascorbic and sodium chloride (Hydrocooling), Chitosan/Acid solution (edible coating) and packed with an injection of 50-70% gas mixture (2-6% O₂, 8-12% CO₂ and 82-90% N₂) in a flexible 70 micron thick bag; the AMA M9 samples reached the 31-day shelf life goal in all parameters evaluated: physical-chemical, microbiological and sensory, both in uncooked and cooked samples.

The results of the sensory evaluation indicate that the decreasing trend of sensory quality of the two treatments 5^{th} RANGE—AMA (M2, M3 and M4) and 5^{th} RANGE—AMA (M6, M7 and M8) in their three storage conditions: no interruption, one interruption and two cold chain interruptions is similar throughout their evaluation, maintaining a range between approximately 7 to 5.5 being indifferent to the cold chain interruptions. However, the uncooked samples of the 5^{th} Range—AMA treatment (M6, M7 and M8) have better sensory acceptance by the panelists and the cooked samples of this treatment are similar to the cooked and uncooked samples of the 5^{th} Range—AMA treatment (M2, M3 and M4).

1-16. (canceled)

17. A process for vegetable conservation comprising the steps of:
performing a first immersion of a vegetable in a first antioxidant solution comprising citric acid and ascorbic acid;
performing a second immersion in a second antioxidant solution comprising citric acid, ascorbic acid and sodium chloride;
cooking said vegetable in a third solution comprising citric acid, ascorbic acid and sodium chloride;
hydrocooling the vegetable with the third solution;
performing a third immersion into a fourth edible coating solution;
bagging the vegetable; and
sealing the bag with an active modified atmosphere, a passive modified atmosphere or at vacuum.

18. A process according to claim 17, where the vegetable is selected from the group comprising: varieties of Cynara scolymus; species and varieties of the Capsicum genus; varieties of Pisum sativum; varieties of Asparagus officinalis; and varieties of Phaseolus Vulgaris.

19. A process according to claim 17, wherein the vegetable is subjected to at least one of: washing, disinfecting or peeling prior to the first immersion.

20. A process according to claim 19 where washing is performed with a food detergent and disinfecting is performed with peracetic acid.

21. A process according to claim 17, wherein the first antioxidant solution comprises said citric acid at a concentration of between 0.5% to 1.5% relative to the total weight of the first solution and said ascorbic acid at a concentration of between 0.1% up to 1% relative to the total weight of the first solution.

22. A process according to claim 17, wherein the second antioxidant solution comprises said citric acid at a concentration of between 0.1% up to 1% in relation to the total weight of the second solution; said ascorbic acid at a concentration of between 0.1% to 0.5% relative to the total weight of the second solution and said sodium chloride at a concentration of between 0.5% up to 1% in relation to the total weight of the second solution.

23. A process according to claim 17, wherein the third solution comprises said citric acid at a concentration of between 0.1% to 0.5% relative to the total weight of the third solution; said ascorbic acid at a concentration of between 0.05% to 0.15% relative to the total weight of the third solution; and said sodium chloride at a concentration of between 0.1% to 0.5% relative to the total weight of the third solution.

24. A process according to claim 17, where said vegetable is cooked at a temperature between 85 to 105° C. for a time range of between 4 to 20 minutes.

25. A process according to claim 17, wherein the vegetable is hydrocooled until the temperature of the vegetable is less than 6° C.

26. A process according to claim 17, wherein the fourth edible coating solution comprises a combination of ascorbic acid and calcium at a concentration of between 10 to 16% in relation to the total weight of the fourth edible coating solution, where ascorbate ions and calcium ions are present in a ratio of 1.5:1 to 3:1, respectively.

27. A process according to claim 17, wherein the fourth edible coating solution comprises a combination of ascorbic acid and calcium at a concentration of between 10 to 16% relative to the total weight of the fourth edible coating solution, where ascorbate ions and calcium ions are present at a ratio of 1.5:1 to 3:1, respectively, and chitosan at a concentration of between 0.4% to 0.6% relative to the total weight of the fourth edible coating solution.

28. A process according to claim 17, where in the third immersion the fourth edible coating solution is at a temperature below 6° C.

29. A process according to claim 17, wherein said bag is sealed with the active modified atmosphere by injecting a mixture of gases at a concentration of between 50 to 70% of the bag consisting of 2 to 6% of O₂, 8 to 12% of CO₂, and 82 to 90% of N₂.

30. A process according to claim 17, wherein said vegetable is a V range vegetable.

31. A process according to claim 17, wherein said vegetable is a ready to eat vegetable.

32. A process according to claim 17, wherein said vegetable is a ready to use vegetable.

33. A process according to claim 17, further comprising the steps of storing and transporting said bagged vegetable.

34. A process according to claim 33, wherein said bagged vegetable is stored and transported at a temperature below 5° C.
